(19) United States
(12) Patent Application Publication
(10) Pub. No.: US 2025/0088426 A1
(43) Pub. Date: Mar. 13, 2025

(54) COMMUNICATION METHOD AND APPARATUS

(71) Applicant: HUAWEI TECHNOLOGIES CO., LTD., Shenzhen (CN)

(72) Inventors: Yan XI, Shanghai (CN); Xueqiang YAN, Shanghai (CN); Mingyu ZHAO, Shanghai (CN)

(73) Assignee: HUAWEI TECHNOLOGIES CO., LTD., Shenzhen (CN)

(21) Appl. No.: 18/963,171

(22) Filed: Nov. 27, 2024

Related U.S. Application Data
(63) Continuation of application No. PCT/CN2023/094626, filed on May 16, 2023.

(30) Foreign Application Priority Data
May 31, 2022 (CN) 202210613730.3

(51) Int. Cl. H04L 41/12; H04L 9/40

(52) U.S. Cl. CPC H04L 41/12; H04L 63/10

(57) ABSTRACT

An example method includes: A first data agent network element obtains first data, receives first indication information and second indication information, where the first indication information includes an indication of an operation performed by the first data agent network element on the first data, the second indication information indicates information about a first network element interacting with the first data agent network element, and the information about the first network element includes address information of the first network element or an identifier of the first network element, or is used to determine the address information that is of the first network element and that is reported by the first data agent network element. The first data agent network element performs the operation on the first data, to obtain first information and sends the first information based on the information about the first network element.

### CROSS-REFERENCE TO RELATED APPLICATIONS

This application is a continuation of International Application No. PCT/CN2023/094626, filed on May 16, 2023, which claims priority to Chinese Patent Application No. 202210613730.3, filed on May 31, 2022. The disclosures of the aforementioned applications are hereby incorporated by reference in their entireties.

### TECHNICAL FIELD

This application relates to the communication field, and in particular, to a communication method and an apparatus.

### BACKGROUND

Data plays an important role in a communication network. A data service is needed for efficient use of the data. In a data service (DS), data acquisition, data pre-processing, data distribution, data release, data analytics, and other operations may be performed on data, and the obtained data is provided as a service product. In other words, in the communication network, a data service-based architecture is a complete architecture throughout a whole life cycle from data generation to consumption result feedback.

With development of a scale of a mobile communication network, a new technology, and the like, data in the mobile communication network is increasing, and a requirement for the data service is also increasing. Therefore, the data in the mobile communication network may be processed based on a data service architecture, to implement the data service. However, because data types, data quality, data attributes, and the like are greatly different, and procedures such as the data acquisition, the data pre-processing, and the data analytics are different, there is a huge requirement difference between generation and consumption that are of the data. Therefore, processing the data in the mobile communication network based on the data service architecture to implement the data service is an important problem to be further studied.

### SUMMARY

Embodiments of this application provide a communication method and an apparatus, to process data in a mobile communication network based on a data service architecture, to implement a data service.

To achieve the foregoing objective, the following technical solutions are used in embodiments of this application.

According to a first aspect, a communication method is provided. The method may be performed by a first data agent network element, or may be performed by a component in the first data agent network element, for example, a processor, a chip, or a chip system in the first data agent network element, or may be implemented by a logical module or software that can implement all or some functions of the first data agent network element. The following uses an example in which the method is performed by the first data agent network element for description. The communication method includes: The first data agent network element obtains first data. The first data agent network element receives first indication information and second indication information, where the first indication information includes an indication of an operation performed by the first data agent network element on the first data, the second indication information indicates information about a first network element interacting with the first data agent network element, and the information about the first network element includes address information of the first network element or an identifier of the first network element, or is used to determine the address information that is of the first network element and that is reported by the first data agent network element. The first data agent network element performs the operation on the first data, to obtain first information. The first data agent network element sends the first information based on the information about the first network element.

In other words, in this embodiment of this application, the first data agent network element may obtain the first information based on the first indication information, interact with the first network element based on the information indicated in the second indication information, to form a data service architecture in which the first data agent network element directly interacts with the first network element, and further process the data in a mobile communication network based on the data service architecture formed by the first data agent network element and the first network element, to implement a data service.

In a possible implementation, the first data includes data acquired by the first data agent network element from at least one data source, and/or data received by the first data agent network element from a second network element.

In a possible implementation, the operation indicated in the first indication information includes one or more of the following: target data acquisition, target data pre-processing, target data storage, target data analytics, or target data protection.

It needs to be noted that the operation indicated in the first indication information in this application is different from common encoding/decoding, a modulation/demodulation operation, and rate matching.

In a possible implementation, the first data includes the data acquired by the first data agent network element from the at least one data source, and the at least one data source includes one or more of the following: a terminal device, a radio access network device, a core network device, a transfer network device, or an operations, administration and maintenance OAM device. In this way, the first data agent network element may acquire a plurality of types of data.

In a possible implementation, the first data includes the data acquired by the first data agent network element from the at least one data source, the data acquired from the at least one data source includes data of a target data source in the at least one data source, and that the first data agent network element obtains first data may include: The first data agent network element sends a first message to the target data source, where the first message is for requesting the data of the target data source. The first data agent network element receives the data from the target data source. In this way, the first data agent network element may interact with a plurality of data sources, so that a compatibility requirement of the data service architecture can be met.

In a possible implementation, the first data includes the data acquired by the first data agent network element from the at least one data source. The communication method provided in this embodiment of this application further includes: The first data agent network element receives a second message from a trust anchor, where the second message indicates that the first data agent network element has permission to access the data acquired from the at least one data source. In other words, in this embodiment of this application, if the first data agent network element has no permission to access the data acquired from the at least one data source, the first data agent network element may reject reception of the data sent by the at least one data source. In this way, a trusted data service can be implemented.

In a possible implementation, before that the first data agent network element receives a second message from a trust anchor, the communication method provided in this embodiment of this application further includes: The first data agent network element sends a third message to the trust anchor, where the third message is used to verify whether the first data agent network element has the permission to access the data acquired from the at least one data source. When the permission for the data that is in the first data and that is acquired from the at least one data source changes, or a new data source with unknown access permission appears in the at least one data source, the first data agent network element may obtain the updated access permission by using the third message, and determine whether to perform this step of obtaining the data acquired from the at least one data source. This can avoid unauthorized access or save signaling resources.

In a possible implementation, the first data includes the data acquired by the first data agent network element from the at least one data source, and the data acquired from the at least one data source includes one or more of the following data: network data, user data, internet of things data, or artificial intelligence model data.

In a possible implementation, the first data includes the data received by the first data agent network element from the second network element, and that the first data agent network element obtains first data may include: The first data agent network element receives the data from the second network element and one or more of the following information: data description information, key information, or file transfer information.

In a possible implementation, the communication method provided in this embodiment of this application further includes: The first data agent network element sends a fourth message to the trust anchor, where the fourth message includes an identifier of first target data in the first data and an identifier of a visitor of the first target data, and the fourth message is for recording an event of accessing the first target data by the visitor of the first target data. Based on this solution, E2E compliance detection of the user data can be implemented.

In a possible implementation, the communication method provided in this embodiment of this application further includes: The first data agent network element receives information about a data security and privacy protection technology repository and/or information about an analytics tool repository, where the data security and privacy protection technology repository is used by the first data agent network element to perform data protection on second target data in the first data, and the analytics tool repository is used by the first data agent network element to perform data analytics on third target data in the first data. Based on this solution, when the data security and privacy protection technology repository, the analytics tool repository, and the like are updated, the first data agent network element may receive the information about the data security and privacy protection technology repository and/or the information about the analytics tool repository, perform data protection on the second target data in the first data based on the data security and privacy protection technology repository, and perform data analytics on the third target data in the first data based on the analytics tool repository. In this way, data security protection, data privacy protection, or the like can be implemented.

In a possible implementation, the first data agent network element is deployed in one or more of the following devices: the terminal device, the radio access network device, the core network device, the transfer network device, or the operations, administration and maintenance OAM device. In this way, the plurality of types of data can be acquired.

In a possible implementation, the communication method provided in this embodiment of this application further includes: The first data agent network element sends data service capability information, where the data service capability information is used to determine the first indication information and/or the second indication information.

In a possible implementation, the data service capability information includes one or more of the following: an identifier of the first data agent network element, location information of the first data agent network element, a data pre-processing capability of the first data agent network element, a data storage capability of the first data agent network element, a data reporting capability of the first data agent network element, a data analytics capability of the first data agent network element, an interaction capability of the first data agent network element, a data protection capability of the first data agent network element, or a data compression capability of the first data agent network element.

According to a second aspect, a communication apparatus is provided, to implement the foregoing methods. The communication apparatus may be the first data agent network element in the first aspect, or an apparatus including the first data agent network element, or an apparatus, for example, a chip, included in the first data agent network element. The communication apparatus includes a corresponding module, unit, or means (means) for implementing the foregoing method. The module, unit, or means may be implemented by hardware, software, or hardware executing corresponding software. The hardware or the software includes one or more modules or units corresponding to the foregoing functions.

In some possible implementations, the communication apparatus may include: a processing module and a transceiver module. The transceiver module may also be referred to as a transceiver unit, and is configured to implement a sending function and/or a receiving function in any one of the first aspect or the possible implementations of the first aspect. The transceiver module may include a transceiver circuit, a transceiver device, a transceiver, or a communication interface. The processing module may be configured to implement a processing function in any one of the first aspect and the possible implementations of the first aspect.

For example, the processing module is configured to obtain first data. The transceiver module is configured to receive first indication information and second indication information. The first indication information includes an indication of an operation performed by the first data agent network element on the first data, the second indication information indicates information about a first network element interacting with the first data agent network element, and the information about the first network element includes address information of the first network element or an identifier of the first network element, or is used to determine the address information that is of the first network element and that is reported by the first data agent network element. The processing module is further configured to perform the foregoing operation on the first data, to obtain first information. The transceiver module is further configured to send the first information based on the information about the first network element.

For example, the first data includes data acquired by the first data agent network element from at least one data source, and/or data received by the first data agent network element from a second network element.

For example, the operation indicated in the first indication information includes but is not limited to one or more of the following: target data acquisition, target data pre-processing, target data storage, target data analytics, or target data protection.

For example, the first data includes the data acquired by the first data agent network element from the at least one data source, and the at least one data source includes one or more of the following: a terminal device, a radio access network device, a core network device, a transfer network device, or an operations, administration and maintenance OAM device.

For example, the first data includes the data acquired by the first data agent network element from the at least one data source, the data acquired from the at least one data source includes data of a target data source in the at least one data source, and that the processing module is configured to obtain first data includes: sending a first message to the target data source by using the transceiver module, where the first message is for requesting the data of the target data source; and receiving the data from the target data source by using the transceiver module.

For example, the first data includes the data acquired by the first data agent network element from the at least one data source, and the transceiver module is further configured to receive a second message from a trust anchor, where the second message indicates that the first data agent network element has permission to access the data acquired from the at least one data source.

For example, the transceiver module is further configured to send a third message to the trust anchor before receiving the second message from the trust anchor, where the third message is used to verify whether the first data agent network element has the permission to access the data acquired from the at least one data source.

For example, the first data includes the data acquired by the first data agent network element from the at least one data source, and the data acquired from the at least one data source includes but is not limited to one or more of the following data: network data, user data, internet of things data, or artificial intelligence model data.

For example, the first data includes the data received by the first data agent network element from the second network element, and that the processing module obtains first data includes: receiving, by using the transceiver module, the data from the second network element and one or more of the following information: data description information, key information, or file transfer information.

For example, the transceiver module is further configured to send a fourth message to the trust anchor, where the fourth message includes an identifier of first target data in the first data and an identifier of a visitor of the first target data, and the fourth message is for recording an event of accessing the first target data by the visitor of the first target data.

For example, the transceiver module is further configured to receive information about a data security and privacy protection technology repository and/or information about an analytics tool repository, where the data security and privacy protection technology repository is used by the first data agent network element to perform data protection on second target data in the first data, and the analytics tool repository is used by the first data agent network element to perform data analytics on third target data in the first data.

For example, the first data agent network element in this embodiment of this application may be deployed in one or more of the following devices: the terminal device, the radio access network device, the core network device, the transfer network device, or the operations, administration and maintenance OAM device.

For example, the transceiver module is further configured to send data service capability information, where the data service capability information is used to determine the first indication information and/or the second indication information.

For example, the data service capability information includes one or more of the following: an identifier of the first data agent network element, location information of the first data agent network element, a data pre-processing capability of the first data agent network element, a data storage capability of the first data agent network element, a data reporting capability of the first data agent network element, a data analytics capability of the first data agent network element, an interaction capability of the first data agent network element, a data protection capability of the first data agent network element, or a data compression capability of the first data agent network element.

It needs to be noted that the transceiver module according to the second aspect may include: a receiving module and a sending module. A specific implementation of the transceiver module is not specifically limited in this application.

Optionally, the communication apparatus according to the second aspect may further include a storage module. The storage module stores a program or instructions. When the processing module executes the program or the instructions, the communication apparatus according to the second aspect is enabled to perform the method according to the first aspect.

In addition, for technical effects of the communication apparatus according to the second aspect, refer to technical effects of the communication method according to any possible implementation of the first aspect. Details are not described herein again.

According to a third aspect, a communication apparatus is provided. The communication apparatus includes at least one processor. The processor is configured to execute a computer program or instructions stored in a memory, to enable the communication apparatus to perform the communication method according to the first aspect. The memory may be coupled to the processor, or may be independent of the processor. The communication apparatus may be the data agent network element in the first aspect, or an apparatus including the data agent network element, or an apparatus, for example, a chip, included in the data agent network element.

In a possible implementation, the communication apparatus further includes the memory.

According to a fourth aspect, a communication apparatus is provided. The communication apparatus includes: a processor and a communication interface. The communication interface is configured to communicate with a module outside the communication apparatus. The processor is configured to execute a computer program or instructions, to enable the communication apparatus to perform the method according to the first aspect. The communication apparatus may be the data agent network element in the first aspect, or an apparatus including the data agent network element, or an apparatus, for example, a chip, included in the data agent network element.

In some embodiments, the communication interface may be implemented by using an interface circuit included in the communication apparatus.

According to a fifth aspect, a communication apparatus is provided. The communication apparatus includes: a processor and a transceiver. The transceiver is configured to exchange information between the communication apparatus and another communication apparatus. The processor executes program instructions, to perform the communication method in the first aspect. The communication apparatus may be the data agent network element in the first aspect, or an apparatus including the data agent network element, or an apparatus, for example, a chip, included in the data agent network element.

According to a sixth aspect, a computer-readable storage medium is provided. The computer-readable storage medium stores a computer program or instructions. When the computer program or instructions are run on a communication apparatus, the communication apparatus may be enabled to perform the method according to the first aspect.

According to a seventh aspect, a computer program product including instructions is provided. When the computer program product runs on a communication apparatus, the communication apparatus may be enabled to perform the method according to the first aspect.

According to an eighth aspect, a communication apparatus (for example, the communication apparatus may be a chip or a chip system) is provided. The communication apparatus includes a processor, configured to implement functions in the first aspect.

In some possible designs, the communication apparatus includes a memory, and the memory is configured to store necessary program instructions and data.

In some possible designs, when the apparatus is a chip system, the apparatus may include a chip, or may include the chip and another discrete device.

It may be understood that, when the communication apparatus provided in any one of the third aspect to the eighth aspect is a chip, the foregoing sending action/function may be understood as an output, and the foregoing receiving action/function may be understood as an input.

For technical effects achieved by any one of the design manners of the third aspect to the eighth aspect, refer to technical effects achieved by the different design manners of the first aspect. Details are not described herein again.

### BRIEF DESCRIPTION OF DRAWINGS

FIG. 1 is a diagram of an architecture of a communication system according to an embodiment of this application;

FIG. 2 is a diagram of a data service architecture according to an embodiment of this application;

FIG. 3 is a diagram of a function of a data service architecture according to an embodiment of this application;

FIG. 4 is a schematic of a logical network topology according to an embodiment of this application;

FIG. 5a and FIG. 5b are diagrams of some operation chains according to embodiments of this application;

FIG. 6a to FIG. 6d are diagrams of some network architectures according to embodiments of this application;

FIG. 7 is a diagram of a structure of a communication apparatus according to an embodiment of this application;

FIG. 8 is a schematic flowchart of a communication method according to an embodiment of this application; and

FIG. 9 is a diagram of a structure of a first data agent network element according to an embodiment of this application.

### DESCRIPTION OF EMBODIMENTS

The following describes the technical solutions in embodiments of this application with reference to the accompanying drawings in embodiments of this application. In the descriptions of this application, unless otherwise specified, “/” indicates that associated objects are in an “or” relationship. For example, A/B may represent A or B. In this application, “and/or” describes only an association relationship between associated objects and represents that three relationships may exist. For example, A and/or B may represent: Only A exists, both A and B exist, and only B exists, where A and B may be singular or plural. In addition, in the descriptions of this application, “a plurality of” refers to two or more than two unless otherwise specified. “At least one of the following items (pieces)” or a similar expression thereof refers to any combination of these items, including any combination of singular items (pieces) or plural items (pieces). For example, at least one item (piece) of a, b, or c may indicate: a, b, c, a and b, a and c, b and c, or a, b, and c, where a, b, and c may be singular or plural. In addition, to clearly describe the technical solutions in embodiments of this application, terms such as “first” and “second” are used in embodiments of this application to distinguish between same items or similar items that provide basically same functions or purposes. Persons skilled in the art may understand that the terms such as “first” and “second” do not limit a quantity or an execution sequence, and the terms such as “first” and “second” do not indicate a definite difference.

In addition, the network architecture and the service scenario described in embodiments of this application are intended to describe the technical solutions in embodiments of this application more clearly, and do not constitute a limitation on the technical solutions provided in embodiments of this application. Persons of ordinary skill in the art may know that: With the evolution of the network architecture and the emergence of new service scenarios, the technical solutions provided in embodiments of this application are also applicable to similar technical problems.

The technical solutions in embodiments of this application may be applied to various communication systems, for example, a universal mobile telecommunications system (universal mobile telecommunications system, UMTS), a wireless local area network (wireless local area network, WLAN), a wireless fidelity (wireless fidelity, Wi-Fi) system, a wired network, a vehicle-to-everything (vehicle-to-everything, V2X) communication system, a device-to-device (device-to-device, D2D) communication system, an internet of vehicles communication system, a 4th generation (4th generation, 4G) mobile communication system like a long term evolution (long term evolution, LTE) system or a worldwide interoperability for microwave access (worldwide interoperability for microwave access, WiMAX) communication system, a 5th generation (5th generation, 5G) mobile communication system like a new radio (new radio, NR) system, and a future communication system like a 6th generation (6th generation, 6G) mobile communication system.

All aspects, embodiments, or features are presented in this application by describing a system that may include a plurality of devices, assemblies, modules, or the like. It should be appreciated and understood that, each system may include another device, assembly, module, or the like, and/or may not include all devices, assemblies, modules, or the like discussed with reference to the accompanying drawings. In addition, a combination of these solutions may be further used.

In addition, in embodiments of this application, terms such as “example” and “for example” are used to represent giving an example, an illustration, or a description. Any embodiment or design solution described as an “example” in this application should not be explained as being more preferred or having more advantages than another embodiment or design solution. Exactly, the term “example” is used to present a concept in a specific manner.

In embodiments of this application, sometimes “of (of)”, “corresponding (corresponding, relevant)”, and “corresponding (corresponding)” may be mixed. It should be noted that when differences are not emphasized, meanings expressed by the terms are the same.

A network architecture and a service scenario described in embodiments of this application are intended to describe the technical solutions in embodiments of this application more clearly, and do not constitute a limitation on the technical solutions provided in embodiments of this application. Persons of ordinary skill in the art may know that: With evolution of the network architecture and emergence of new service scenarios, the technical solutions provided in embodiments of this application are also applicable to similar technical problems.

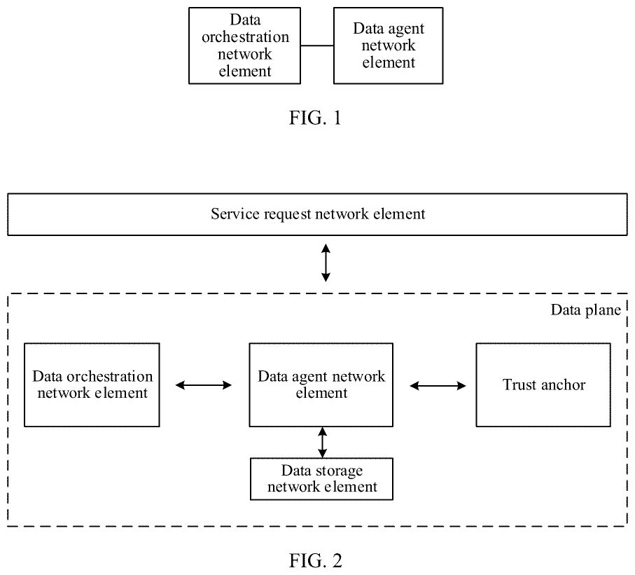

For ease of understanding embodiments of this application, a communication system shown in FIG. 1 is first used as an example to describe in detail a communication system applicable to an embodiment of this application. For example, FIG. 1 is a diagram of an architecture of a communication system to which a communication method is applicable according to an embodiment of this application.

As shown in FIG. 1, the communication system includes a data orchestration (data orchestration, DO) network element and a data agent (data agent, DA) network element. There may be one or more data orchestration network elements, and there may be one or more data agent network elements.

It needs to be noted that the network element may be a logical entity or a physical entity. In embodiments of this application, a “device” and a “network element” may be replaced for description. This is uniformly described herein, and details are not described below again.

The data orchestration network element may obtain a service request, translate the service request into service requirements on data, determine data agent network elements for implementing the service requirements, and orchestrate functions of the data agent network elements, so that the data agent network elements perform corresponding operations and establish a dynamic logical network topology, to implement the corresponding service requirements.

For example, the data orchestration network element may be deployed in any core network (core network, CN) device, transfer network (transfer network, TN) device, or access network (radio access network, RAN) device, or another device/network element (for example, an operations, administration and maintenance (operations, administration and maintenance, OAM) network element), or the data orchestration network element may be independently deployed. For example, the data orchestration network elements may be hierarchically deployed on a CN device side or a RAN device side. The data orchestration network element may be deployed in a network service (network service, NS) network element. For another example, the data orchestration network element may be independently deployed in a network as a network function (network function, NF) or a network element. In actual deployment, one or more NFs may form a network element.

The data agent network element may implement one or more of the following functions: data acquisition, pre-processing, storage, analytics, data protection, and the like. Different data agent network elements may have a same data service capability or different data service capabilities, and may implement a same function or different functions. The data agent network element may interact with the data orchestration network element, to obtain a related operation that needs to be performed to meet a service requirement, and perform the operation. The data agent network elements may establish the logical network topology to form a dynamic data pipeline (data pipeline) (or referred to as a data flow, service logic, a function chain, an operation chain, or the like). The data pipeline includes the functions corresponding to the one or more data agent network elements based on the service requirements, and an output of a former function is an input of a latter function, to implement a corresponding data service.

The data agent network element may be deployed in any core network device, transfer network device, terminal device, or access network device, or another device/network element (for example, an OAM device), or the data agent network element may be independently deployed. For example, the data agent network element may be independently deployed in the network as a network function NF or a network element.

For example, the data agent network element may be evolved from a network data analytics function (network data analytics function, NWDAF) network element, and can implement a function of the NWDAF network element, a scenario case implemented based on the NWDAF network element, and the like.

Optionally, the data agent network element may be optionally deployed in the any core network device, transfer network device, terminal device, or access network device, or the another network element based on a resource and/or a capability of the network element, to implement cross-domain data acquisition. The data agent network element may acquire data from a whole domain, to implement cross-domain data management and collaboration.

For example, as the network function NF, the data agent network element can match cloud native SBI encryption, NF dynamic instantiation, and a K8S deployment encryption environment. In addition, impact on a performance loss and security of the NF can be minimized.

When there are the plurality of data agent network elements in the communication system, some data agent network elements may be disposed inside a network device (which refers to the any core network device, terminal device, access network device, or the another network element), and some data agent network elements are independently deployed; or the plurality of data agent network elements are all disposed inside a network device, or the plurality of data agent network elements are all independently deployed. This is not limited in this application.

It needs to be noted that the data orchestration network element may be a logical entity or a physical entity, and the data agent network element may be a logical entity or a physical entity. This is not limited in this application.

For example, the data agent network element may be deployed in a centralized manner or in a distributed manner.

The data agent network element is flexibly deployed in a distributed manner as required, which can meet diversified and flexible data service requirements and reduce data acquisition overheads.

The core network device is located on a network side of the communication system, and may be configured to provide a network service for the access network device, the terminal device, and the like. The core network device may include but is not limited to one or more of the following: a mobility management network element, a session management network element, a user plane network element, a policy control network element, a network exposure network element, an application network element, the NWDAF network element, and/or the OAM device.

The mobility management network element is mainly used for mobility management, access management, and the like. In a 5G mobile communication system, the access management network element may be an access and mobility management function (access and mobility management function, AMF) network element, and mainly performs functions such as mobility management and access authentication/authorization. In addition, the mobility management network element may be further responsible for transferring a user policy between a terminal and a policy control function (policy control function, PCF) network element.

The session management network element is mainly used for session management (for example, creation or deletion), maintenance of a session context and user plane forwarding tunnel information, internet protocol (internet protocol, IP) address allocation and management for the terminal device, selection of a termination that can manage a user plane function interface and a policy control and charging function interface, a downlink data notification, and the like.

In the 5G communication system, the session management network element may be a session management function (session management function, SMF) network element, and completes terminal IP address allocation, user plane function (user plane function, UPF) selection, charging, quality of service (quality of service, QoS) policy control, and the like.

The user plane network element, as an interface with a data network, completes functions such as user plane data forwarding, session/flow-level-based charging statistics collection, and bandwidth limitation, to be specific, packet routing and forwarding, quality of service QoS handling for user plane data, and the like. In a 5G communication system, the user plane network element may be a UPF network element.

The policy control network element includes a user subscription data management function, a policy control function, a charging policy control function, quality of service QoS control, and the like, is a unified policy framework used to guide network behavior, and provides policy rule information and the like for a control plane function network element (for example, an AMF network element or an SMF network element). In the 5G mobile communication system, the policy control network element may be a PCF.

The network exposure network element may be configured to: provide a framework, authentication, and an interface that are related to network capability exposure, and transfer information between a 5G system network function and another network function. In the 5G communication system, the network exposure network element may be a network exposure function (network exposure function, NEF) network element, and is mainly configured to expose a service and a capability of a mobile communication standardization organization 3rd generation partnership project (3rd generation partnership project, 3GPP) network function to an application function (application function, AF) network element, and may also enable the AF network element to provide information for the 3GPP network function.

The application network element may be configured to provide various services, can interact with a core network through an NEF network element, and can interact with a policy management framework to perform policy management. In the 5G communication system, the application network element may be an AF network element or a time sensitive network application function (time sensitive network application function, TSNAF) network element, represents an application function of a third party or an operator, is an interface for obtaining external application data in a 5G network, and is mainly configured to transfer a requirement of an application side on the network side.

The NWDAF network element may be configured to: acquire data from the core network and the OAM device, and feed back a data analytics result to the NF network element, the AF network element, or the OAM device. For example, the NWDAF network element may acquire OAM data from the OAM device, and acquire non-OAM data from the NF network element in the core network or the AF network element. The non-OAM data may include non-OAM data acquired at levels of a terminal device, a terminal device group, and a service.

The OAM device may acquire data from the access network device.

The access network device may also be referred to as an access device or a radio access network device. The access network device can manage a radio resource, provide an access service for the terminal device, and complete data forwarding between the terminal device and the core network. The access network device may also be understood as a base station in a network.

For example, the access network device in embodiments of this application may be any communication device that has a wireless transceiver function and that is configured to communicate with the terminal device. The access network device includes but is not limited to: an evolved NodeB (evolved NodeB, eNB), a radio network controller (radio network controller, RNC), a NodeB (NodeB, NB), a base station controller (base station controller, BSC), a base transceiver station (base transceiver station, BTS), a home base station (a home evolved NodeB, HeNB, or a home NodeB, HNB), a baseband unit (baseband unit, BBU), an access point (access point, AP) in a wireless fidelity (wireless fidelity, Wi-Fi) system, a wireless relay node, a wireless backhaul node, and a transmission point (transmission point, TP) or a transmission reception point (transmission reception point, TRP); or may be a gNB or a transmission point (TRP or TP) in a 5G system like an NR system, one or one group of antenna panels (including a plurality of antenna panels) of a base station in the 5G system; or may be a network node forming a gNB or a transmission point, like a baseband unit (BBU) or a distributed unit (distributed unit, DU); or may be a satellite and an uncrewed aerial vehicle.

In some deployments, a gNB may include a central unit (central unit, CU) and a DU. The gNB may further include an active antenna unit (active antenna unit, AAU). The CU implements some functions of the gNB, and the DU implements some functions of the gNB. For example, the CU is responsible for processing a non-real-time protocol and service, and implements functions of a radio resource control (radio resource control, RRC) layer and a packet data convergence protocol (packet data convergence protocol, PDCP) layer. The DU is responsible for processing a physical layer protocol and a real-time service, and implements functions of a radio link control (radio link control, RLC) layer, a media access control (media access control, MAC) layer, and a physical layer (physical layer, PHY). The AAU implements some physical layer processing functions, radio frequency processing, and a function related to an active antenna. Information at the RRC layer is generated by the CU, and is finally encapsulated at the PHY layer of the DU into information at the PHY layer, or is obtained through conversion from the information at the PHY layer. Therefore, in this architecture, higher layer signaling, for example, RRC layer signaling, may also be considered to be sent by the DU, or sent by the DU and the AAU. It may be understood that the access network device may be a device including one or more of a CU node, a DU node, or an AAU node. In addition, the CU may be classified as an access network device in an access network, or the CU may be classified as an access network device in the core network. This is not limited in this application.

The terminal device is a terminal accessing the communication system and having a wireless transceiver function, or a chip or a chip system that may be disposed in the terminal. In this application, the terminal device may also be referred to as a terminal, user equipment (user equipment, UE), an access terminal, a subscriber unit, a subscriber station, a mobile station, a remote station, a remote terminal, a mobile device, a user terminal, a wireless communication device, a user agent, or a user apparatus. The terminal in embodiments of this application may be a mobile phone (mobile phone), a tablet computer (pad), an uncrewed aerial vehicle, a computer having a wireless transceiver function, customer premise equipment (customer premise equipment, CPE), a virtual reality (virtual reality, VR) terminal, an augmented reality (augmented reality, AR) terminal, a wireless terminal in industrial control (industrial control), a wireless terminal in self driving (self driving), a wireless terminal in telemedicine (remote medical), a wireless terminal in a smart grid (smart grid), a wireless terminal in transportation safety (transportation safety), a wireless terminal in a smart city (smart city), a wireless terminal in a smart home (smart home), a cellular phone, a cordless phone, a session initiation protocol (session initiation protocol, SIP) phone, a wireless local loop (wireless local loop, WLL) station, a personal digital assistant (personal digital assistant, PDA), a handheld device or a computing device having a wireless communication function, another processing device, vehicle-mounted device, or wearable device, or unmanned aerial vehicle connected to a wireless modem, a terminal in the 5G network, a terminal in a future evolved network, or the like.

For another example, the terminal device in this application may be an express delivery terminal (for example, a device that can monitor a location of a cargo vehicle, or a device that can monitor a temperature and humidity of a cargo) in intelligent logistics, a wireless terminal (for example, a wearable device that can acquire related data of poultry and livestock) in intelligent agriculture, a wireless terminal (for example, a smart elevator, a fire monitoring device, or a smart meter) in intelligent architecture, a wireless terminal (for example, a wearable device that can monitor a physiological status of a person or an animal) in intelligent healthcare, a wireless terminal (for example, an intelligent bus, an intelligent vehicle, a shared bicycle, a charging pile monitoring device, intelligent traffic lights, or an intelligent monitoring and intelligent parking device) in intelligent transportation, or a wireless terminal (for example, a vending machine, a self-service checkout machine, or an unmanned convenience store) in intelligent retail. For another example, the terminal device in this application may be a vehicle-mounted module, a vehicle-mounted assembly, a vehicle-mounted component, a vehicle-mounted chip, or a vehicle-mounted unit that is disposed inside a vehicle as one or more components or units. The vehicle may implement the method provided in this application by using the vehicle-mounted module, the vehicle-mounted assembly, the vehicle-mounted component, the vehicle-mounted chip, or the vehicle-mounted unit that is disposed inside the vehicle. The terminal device in this application may be a smart internet of things (smart internet of things, SIoT) terminal device or a non-SIoT terminal device, and has specific computing, storage, and other capabilities. The non-SIoT terminal device may acquire data by using an internet of things gateway. For example, the non-SIoT terminal device may be a terminal with a limited computing capability, for example, a sensor with a single function. Optionally, the data agent network element may be disposed inside the SIoT terminal device, or the SIoT terminal device may implement a function of the data agent network element.

It should be understood that FIG. 1 is merely a simplified diagram of an example for ease of understanding. The communication system may further include other devices, for example, a trust anchor (trust anchor, TA), a service request network element, and/or a data storage network element (for a specific implementation, refer to the following corresponding descriptions in FIG. 2), which are not shown in FIG. 1.

For example, FIG. 2 is a diagram of a data service architecture according to an embodiment of this application. The communication system shown in FIG. 1 is applicable to the data service architecture shown in FIG. 2.

As shown in FIG. 2, this application proposes a case that the normalized data service architecture is constructed based on a data plane, to provide a data service for a service request network element. The data service architecture may include but is not limited to one or more of the following: a data orchestration network element, a data agent network element, a trust anchor, the service request network element, and a data storage network element.

The trust anchor may provide trusted services such as authentication, authorization, and access control (authentication authorization access control, AAA), which, for example, may be implemented by using a distributed ledger technology (distributed ledger technology, DLT). The trust anchor may store data that cannot be tampered with, for example, a public key, an identifier, or an index of a terminal device or a network element, transaction-related data, or important data that cannot be tampered with.

Optionally, a storage capability of the distributed ledger technology may be extended in on-chain (on-chain) and off-chain (off-chain) storage manners. For example, original data is stored locally in the data agent network element or in the data storage network element (off-chain), a hash value for the original data or a hash value for a digest of packaged original data is stored in an extended DLT (on-chain), and an address for pointing to the original data is also stored in the DLT (on-chain). The original data stored off-chain or the new hash value generated by the digest of the original data is compared with a hash value stored on-chain, to prevent the original data from being tampered with.

For example, the trust anchor may be deployed in a distributed or centralized manner. The trust anchor deployed in the distributed manner may be a node in the distributed ledger technology DLT (for example, a blockchain), and the like. The trust anchor deployed in the centralized manner may be implemented through reconstruction and evolution of existing security and trust mechanisms such as authentication, authorization, and access control.

For example, the trust anchor can implement a security and privacy protection mechanism for an entire data service procedure through data access control such as authentication, authorization, and access control, and in combination with a data security and privacy protection technology repository, can support security and privacy protection of the entire data service procedure, can support trusted data service requirements such as source tracing, auditability, and user data autonomous control, can support meeting requirements of data sharing and transaction on trusted mechanisms such as source tracing and auditability, can meet compliance requirements such as the personal information protection law (personal information protection law, PIPL) and the general data protection regulation (general data protection regulation, GDPR), and can provide a trusted data service. Compliance detection of user data processing can implement a decentralized verification mechanism, to avoid single-point trustworthiness and failure problems.

The service request network element may include an application, an application server, a network service NS network element, or the like. The application may be an application that is of an operator (or a communication service provider (communication service provider, CSP)) and that is used for network planning and optimization, network artificial intelligence (artificial intelligence, AI), and/or the like, or may be an application outside a mobile communication network (which may also be referred to as a third-party application). The service request network element may be independently deployed in a network as a network function or a network element.

The data storage network element may store various types of data, for example, streaming (streaming) data, batch (batch) data, log (log) information, AI model parameter configuration information, and intermediate data, and may extend a storage function of the data agent network element. For example, a data storage function (data storage function, DSF) network element may be a centralized database, or may be a distributed database, for example, a distributed hash table DHT or an interplanetary file system (interplanetary file system, IPFS). For example, the data storage network element may be the DSF network element, or may be evolved from the data storage function network element. The data storage network element may be deployed in the network as an NF or a network element.

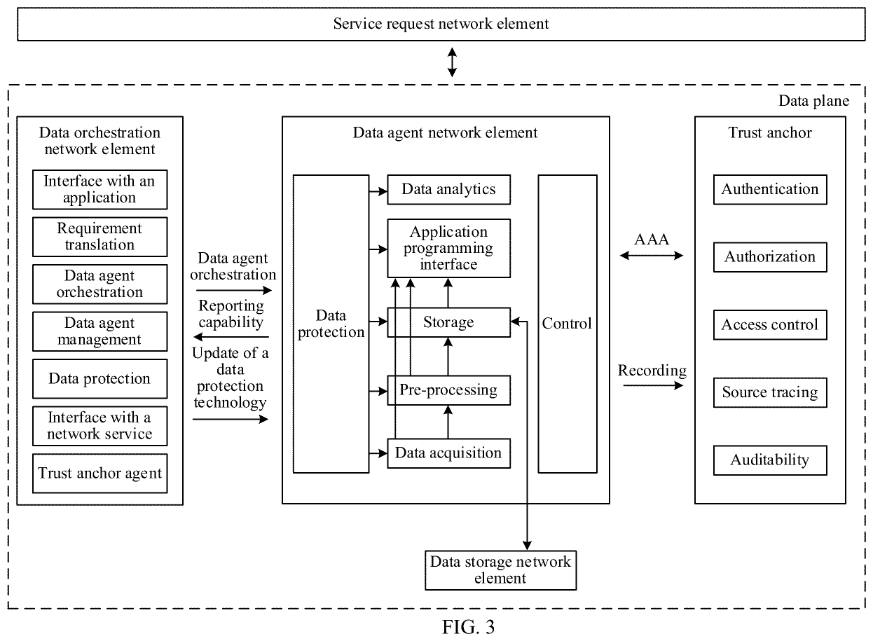

For example, FIG. 3 is a diagram of a function of a data service architecture according to an embodiment of this application.

The following describes a function of a data orchestration network element with reference to FIG. 3.

With reference to FIG. 3, the function that can be implemented by the data orchestration network element includes but is not limited to one or more of the following: an interface with an application, requirement translation, data agent orchestration, data agent management, data protection, an interface with a network service network element, and an interface with a trust anchor.

Interface with the application: The data orchestration network element may interact with a service request network element through the interface with the application. For example, the data orchestration network element receives a service request from the service request network element. For example, the service request may be a requirement filled in according to a standard template. For example, the standard template may be a service level agreement (service level agreement, SLA).

Requirement translation: The data orchestration network element translates the service request into service requirements on functions of data agent network elements. For example, the data orchestration network element translates the requirement such as the service level agreement into a requirement on a corresponding resource and a network configuration.

Data agent orchestration: The data agent network elements are orchestrated based on data service capabilities of the data agent network elements, to form a dynamic logical network topology to meet the service requirement.

For example, the data orchestration network element translates the requirement such as the service level agreement into the requirement on the corresponding resource and the network configuration, selects, based on the data service capabilities of the data agent network elements, data agent network elements participating in a current data service, and orchestrates the data agent network elements to form the dynamic logical network topology.

Optionally, the data orchestration network element may negotiate with another network service network element in a process of performing data agent orchestration. For example, if an algorithm and a computing power need to be used, the data orchestration network element may collaborate with another network service network element, and select a corresponding AI algorithm and computing power, and the network service network element pushes the algorithm.

Optionally, the data orchestration network element may dynamically specify a data agent network element that directly interacts with the service request network element, and send information about the data agent network element to the service request network element, so that the application can invoke an application programming interface (application programming interface, API) of the data agent network element, to obtain data, a processing result, or the like.

Data agent management: Request registration, deregistration, and the like requested from the data orchestration network element by a data agent network element are managed, and a data service capability and the like that are reported by the data agent network element are received.

Data protection: A data protection function may be implemented by using a data protection technology repository (data protection technology repository, DPTR). The data protection technology repository may include a data security and privacy protection algorithm repository, for example, a plurality of algorithms such as differential privacy, homomorphic encryption, multi-party computation, and zero-knowledge proof. The data orchestration network element may push or update information about the data protection technology repository to the data agent network element as required, which serves as a data protection technology (data protection technology, DPT) of the data agent network element. The data protection technology repository can be loosely coupled with the data orchestration network element. The data protection technology repository can be a common capability of a network element in the data service architecture, and can be independently evolved and optimized. The independent data protection technology repository facilitates compliance detection of end-to-end (end-to-end, E2E) data processing.

For example, the information about the data protection technology repository may include an identifier, an index, and configuration information that are of the data protection technology repository, and the data protection technology repository itself.

Interface with the network service: The data orchestration network element may interact with the network service network element through the interface with the network service. For example, the data orchestration network element may negotiate with the network service network element based on a service requirement. For example, if the algorithm and the computing power need to be used, the data orchestration network element may collaborate with the another network service network element.

Trust anchor agent: The trust anchor agent is an interface between the data orchestration network element and the trust anchor. The data orchestration network element may interact with the trust anchor by using a trust anchor agent function.

It needs to be noted that in embodiments of this application, the data orchestration network element may be divided into functional modules based on the foregoing functions or the following method embodiment. For example, each functional module corresponding to each function may be obtained through division, or two or more functions may be integrated into one module. The integrated module may be implemented in a form of hardware, or may be implemented in a form of a software functional module. It needs to be noted that in embodiments of this application, the division into the functions or the modules is an example, and is merely logical function division. During actual implementation, another division manner may be used.

The following describes a function of a data agent network element with reference to FIG. 3.

With reference to FIG. 3, the function that may be implemented by the data agent network element includes but is not limited to one or more of the following: interaction with the data orchestration network element, interaction with the trust anchor, control, data acquisition, data pre-processing, data storage, an application programming interface, data analytics, and data protection.

The data agent network element may implement data service collaboration and closed-loop management by performing the foregoing function, and may output data for different processing requirements as required.

Interaction with the data orchestration network element: The data agent network element is configured to interact with the data orchestration network element, including: sending information to the data orchestration network element, and receiving information about the data orchestration network element. This function of interacting with the data orchestration network element may be implemented by a data orchestration agent of the data orchestration network element.

Interaction with the trust anchor: The data agent network element is configured to interact with the trust anchor. This function of interacting with the trust anchor may be implemented by a trust anchor agent.

Control: Functions of data agent network elements are orchestrated based on operations set by a data orchestration network element for the data agent network elements, to form a data pipeline. The control function may be implemented by a controller (controller) of the data orchestration network element.

For example, the data orchestration network element orchestrates the data agent network elements to form the dynamic logical network topology, and the data agent network elements orchestrate the functions of the data agent network elements to form the data pipeline, to implement automatic data management and dynamic on-demand configuration, promptly respond to a new service and a new requirement, support implementation of rich application scenarios, enable a new data service to quickly appear on a market, and shorten time to market (time to market, TTM).

Data acquisition (acquisition): Data is obtained. For example, the data may be obtained in a subscription/notification manner, or the data is obtained in a request/response manner. Optionally, the request may indicate a data reporting trigger manner, a trigger condition, a reporting periodicity, a data amount, and the like. Optionally, the data agent network element can support streaming data acquisition and batch data acquisition. Optionally, the data agent network element can support real-time data acquisition and non-real-time data acquisition. Optionally, the data agent network element can acquire various types of data. The data may be classified into several types. For example, the types of the data may include but are not limited to: network data, user data, AI model data, and internet of things (internet of things, IoT) data. The classification of the data is not limited in this application, and the data may be classified into more or fewer types, or the data may be classified into types from another perspective, or the data may not be classified into types.

In this way, data services of various types of data can be implemented by using a normalized data service architecture provided in this application.

Data pre-processing (pre-processing): The pre-processing refers to performing cleaning, filling, smoothing, combination, standardization, and consistency checking on acquired original data, field extraction of the original data, format conversion, redundant data clearing, compression, filtering, merging, and/or other operations, to improve data quality and lay a foundation for subsequent processing (for example, analytics). The original data is eliminated, which may result in problems such as a data loss, data noise, data redundancy, and/or dataset imbalance.

Data storage: Centralized and distributed storage is supported. Optionally, data that needs strict access protection or privacy protection, for example, user subscription data, is stored locally in the data agent network element.

Application programming interface: Each function of the data agent network element may directly provide a service for a service requester through the application programming interface API.

Data analytics (analytics): The data analytics is loosely coupled with the data agent network element, and can be deployed separately from the data agent network element as required. Various data analytics technologies can be supported, for example, AI training, AI inference, machine learning (machine learning, ML), and big data analytics. This data analytics function can invoke data services at levels such as data acquisition, pre-processing, and storage of the data agent network element through the API. Optionally, an AI model needed in a data analytics process may be preset locally in the data agent network element or pushed by the network service network element.

Data protection: Data is processed by using technologies such as k-anonymity (k-anonymity), l-diversity (l-diversity), and differential privacy, so that attackers cannot directly obtain sensitive information from anonymized data, to protect data privacy. The information about the data protection technology repository may be pre-installed in the data agent network element, or pushed by the DO as required, and security and privacy protection is performed on data at each level of the data agent network element.

It needs to be noted that in embodiments of this application, the data agent network element may be divided into functional modules based on the foregoing functions or the following method embodiment. For example, each functional module corresponding to each function may be obtained through division, or two or more functions may be integrated into one module. The integrated module may be implemented in a form of hardware, or may be implemented in a form of a software functional module. It needs to be noted that in embodiments of this application, the division into the functions or the modules is an example, and is merely logical function division. During actual implementation, another division manner may be used.

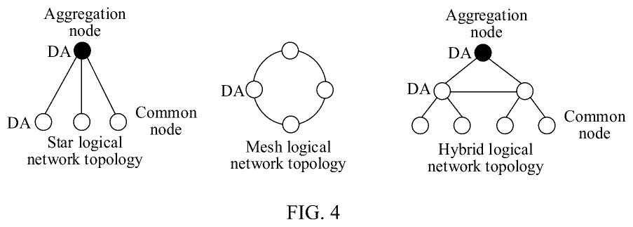

FIG. 4 is a schematic of a logical network topology according to an embodiment of this application. The following describes, with reference to FIG. 4, the logical network topology formed by orchestrating data agent network elements DAs by a data orchestration network element.

As shown in FIG. 4, the logical network topology may include but is not limited to: a star logical network topology, a mesh (mesh) logical network topology, and a hybrid logical network topology.

For example, in the star logical network topology, a DA as an aggregation node may acquire information about common nodes DAs, and may further process the acquired information. Optionally, the DA as the aggregation node may directly interact with a service request network element, and the common node DA may interact with the service request network element via the DA as the aggregation node. This is not limited in this application. The DA that directly interacts with the service request network element may be any DA. The star logical network topology is applicable to scenarios such as data aggregation and federated learning.

For example, in the mesh logical network topology, data collaboration is performed between the DAs, and any DA may be selected to directly interact with the service request network element. For example, in the hybrid (or referred to as hybrid hierarchical) logical network topology, the DA as the aggregation node may hierarchically acquire the information about the common nodes DAs, and may further process the acquired information. Similar to the star logical network topology, the DA as the aggregation node may directly interact with the service request network element, and the common node DA may interact with the service request network element via the DA as the aggregation node. This is not limited in this application. The DA that directly interacts with the service request network element may be any DA.

It needs to be noted that the logical network topology shown in FIG. 4 is merely an example provided in this application. In actual application, the data orchestration network element may orchestrate, as required, the data agent network elements DAs to form a logical network topology in any form, provided that a data service can be implemented.

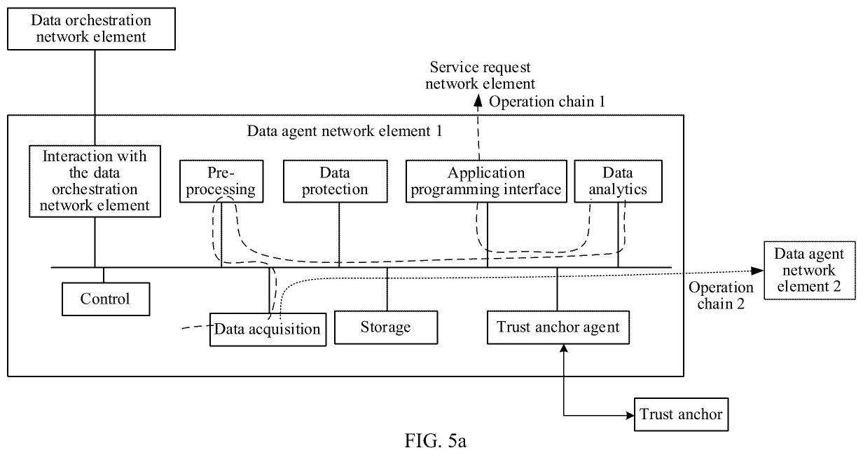

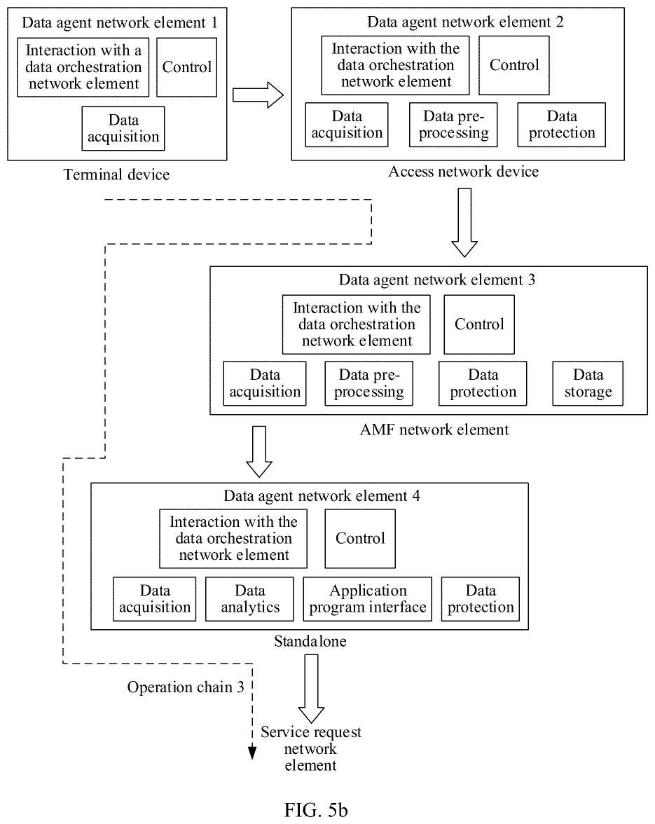

FIG. 5a and FIG. 5b are diagrams of some operation chains according to embodiments of this application. The following describes, with reference to FIG. 5a and FIG. 5b, the operation chain formed by controlling functions of a data agent network element by the data agent network element.

The operation chain is formed by orchestrating the functions of the data agent network element based on an operation that is set by a data orchestration network element for the data agent network element and that is obtained by the data agent network element from the data orchestration network element. For example, as shown in FIG. 5a, it is assumed that an operation that is set for a data agent network element 1 and that is obtained by the data agent network element 1 from the data orchestration network element includes: after pre-processing like merging is performed on data obtained from another data agent network element, analyzing the data to obtain an analytics result, and sending the analytics result to a service request network element. The data agent network element 1 orchestrates functions to form an operation chain 1 shown in FIG. 5a: acquiring data, then pre-processing the data, analyzing a pre-processing result, and sending an analytics result to a service request network element through an application programming interface.

For another example, as shown in FIG. 5a, it is assumed that an operation that is set for a data agent network element 1 and that is obtained by the data agent network element 1 from the data orchestration network element includes: If acquired data is transmitted to a data agent network element 2, the data agent network element 1 orchestrates functions to form an operation chain 2 shown in FIG. 5a: acquiring the data, and sending the data to the data agent network element 2.

For another example, as shown in FIG. 5b, the data agent network element 1 is deployed in a terminal device, the data agent network element 2 is deployed in an access network device, a data agent network element 3 is deployed in an AMF network element, and a data agent network element 4 is independently deployed. It is assumed that the data agent network element 1 obtains, from the data orchestration network element, an operation set for the data agent network element 1, including: sending acquired data to the data agent network element 2; the data agent network element 2 performs data acquisition, data pre-processing, and data protection, and then sends data to the data agent network element 3; the data agent network element 3 performs data acquisition, data storage, data pre-processing, and data protection, and then sends data to the data agent network element 4; and the data agent network element 4 performs data acquisition, data storage, data analytics, data pre-processing, and data protection, and then sends data to the service request network element through an API. The data agent network element 1 to the data agent network element 4 orchestrate respective functions to form an operation chain 3 shown in FIG. 5b: The data agent network element 1 acquires the data, and sends the data to the data agent network element 2; the data agent network element 2 receives the data sent by the data agent network element 1, performs the operation set by the data orchestration network element, and then sends the data to the data agent network element 3; the data agent network element 3 receives the data sent by the data agent network element 2, performs the operation set by the data orchestration network element, and then sends the data to the data agent network element 4; and the data agent network element 4 receives the data sent by the data agent network element 3, performs the operation set by the data orchestration network element, and then sends the data to the service request network element through the API.

It needs to be noted that the operation chain 1, the operation chain 2, and the operation chain 3 shown in FIG. 5a and FIG. 5b are merely examples provided in this application, and do not constitute a limitation on a sequence of performing the functions of the data agent network element. The sequence of performing the functions of the data agent network element may be dynamically adjusted based on a service requirement.

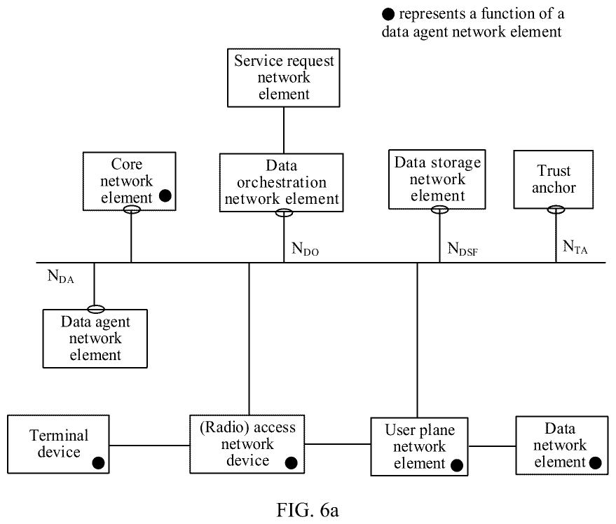

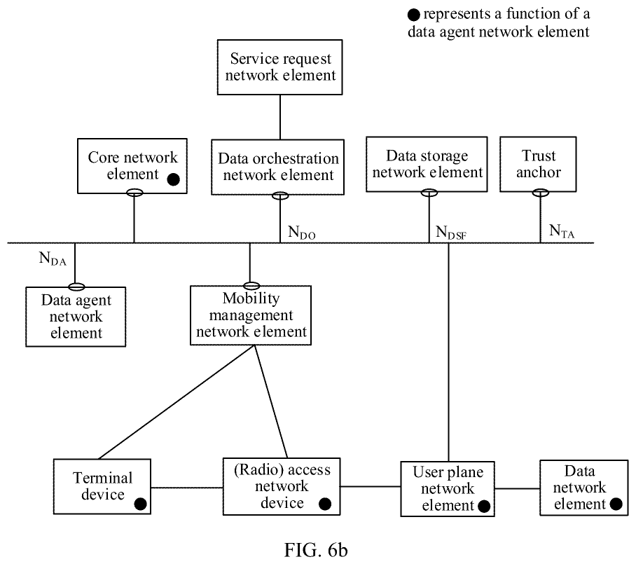

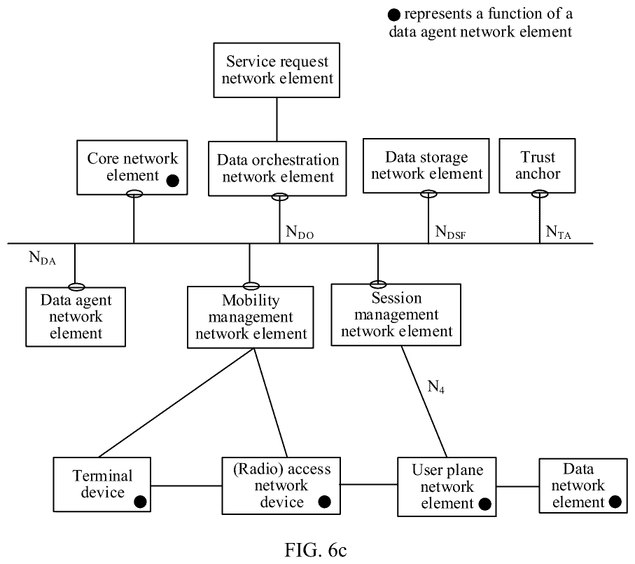

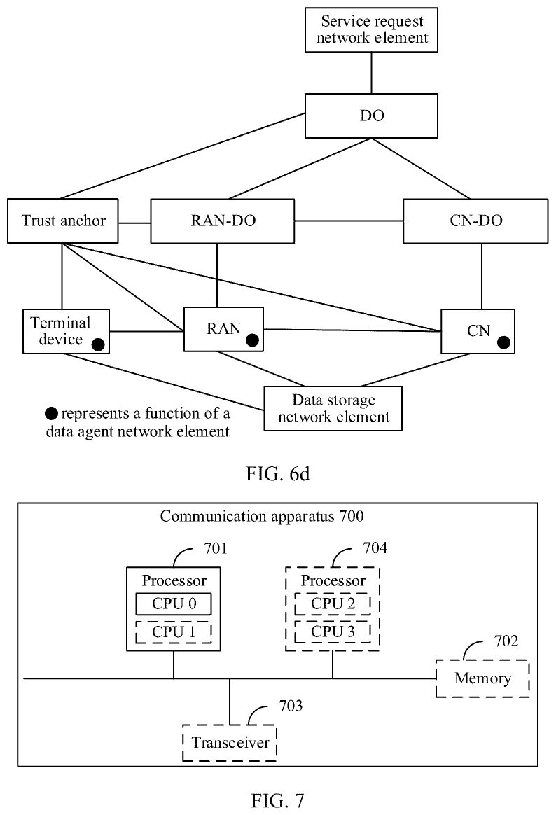

For example, FIG. 6a to FIG. 6d are diagrams of some network architectures according to embodiments of this application. The communication system shown in FIG. 1 is applicable to the network architectures shown in FIG. 6a to FIG. 6d.

FIG. 6a is a diagram of a network architecture used when a core network device and an access network device are all service-oriented. FIG. 6b is a diagram of a network architecture used when an access network device is not service-oriented and a core network is service-oriented. FIG. 6c is a diagram of a network architecture used when an access network device is not service-oriented and a core network is service-oriented (an N4 interface is reserved). FIG. 6d is a diagram of a network architecture in which network elements are directly interconnected.

With reference to FIG. 6a to FIG. 6c, the network architectures may include but are not limited to one or more of the following: a service request network element, a terminal device, an access network device, a user plane network element, a data network element, a core network device, a data orchestration network element, a data agent network element, a data storage network element, a trust anchor, and a service request network element. For a specific implementation, refer to descriptions in FIG. 1 to FIG. 5. Details are not described herein again. The network architectures may further include but are not limited to one or more of the following: a mobility management network element (FIG. 6b and FIG. 6c). The network architecture may further include but is not limited to one or more of the following: a session management network element (FIG. 6c). The core network device shown in FIG. 6a to FIG. 6c may include any core network device other than the user plane network element, the mobility management network element, and/or the session management network element.

The data agent network element may be deployed in any network element other than the data orchestration network element, the data storage network element, and the trust anchor in the network architecture. In other words, any network element other than the data orchestration network element, the data storage network element, and the trust anchor in the network architecture may implement a function of the data agent network element.

The data orchestration network element interacts with another network element (for example, the service request network element, the data agent network element, the core network device, and the trust anchor) through a service-oriented interface N_{DO}, the data agent network element interacts with another network element (for example, the service request network element, the data orchestration network element, the core network device, the terminal device, the access network device, the data storage network element, and the trust anchor) through a service-oriented interface NDA, the data storage network element interacts with another network element (for example, the data agent network element, the core network device, the terminal device, and the access network device) through a service-oriented interface N_{DSF}, and the trust anchor interacts with another network element (for example, the data orchestration network element, the data agent network element, the core network device, the terminal device, the access network device, the data storage network element, and the trust anchor) through a service-oriented interface N_{TA}.

In the network architectures shown in FIG. 6a to FIG. 6c, the service-oriented interfaces may be used, to improve independence between network functions, implement deployment flexibility and efficient scalability, and improve development efficiency of a new function.

With reference to FIG. 6d, the network architecture may include but is not limited to one or more of the following: a service request network element, a data orchestration network element, an access-network-domain data orchestration network element (RAN-DO), a CN-domain data orchestration network element (CN-DO), an access network device RAN, a core network device, a terminal device, a trust anchor, and a data storage network element.

In the architecture shown in FIG. 6d, the data orchestration network elements are hierarchically deployed. The data orchestration network element may manage the RAN-domain data orchestration network element and the CN-domain data orchestration network element. The RAN-domain data orchestration network element may directly interact with the CN-domain data orchestration network element. The RAN-domain data orchestration network element may directly interact with the access network device. The CN-domain data orchestration network element may directly interact with the core network device. The trust anchor may directly interact with any network element in the network architecture. The data storage network element may directly interact with the terminal device, the access network device, and the core network device.

The network elements in the network architecture shown in FIG. 6d are directly interconnected, so that backward compatibility of the architecture can be met.

It needs to be noted that the communication method provided in embodiments of this application is applicable to any two nodes shown in FIG. 1 to FIG. 6d. For a specific implementation, refer to the following method embodiment. Details are not described herein again.

It should be noted that, the solutions in embodiments of this application may be further applied to another communication system, and a corresponding name may also be replaced with a name of a corresponding function in the another communication system.

FIG. 7 is a diagram of a structure of a communication apparatus 700 that may be configured to perform a communication method according to an embodiment of this application. The communication apparatus 700 may be a data orchestration network element, a data agent network element, a service request network element, or a trust anchor, or may be a chip or another component used in the data orchestration network element, the data agent network element, the service request network element, or the trust anchor.

As shown in FIG. 7, a communication apparatus 700 may include a processor 701. Optionally, the communication apparatus 700 may further include one or more of a memory 702 and a transceiver 703. The processor 701 and the one or more of the memory 702 and the transceiver 703 may be coupled, for example, may be connected through a communication bus, or the processor 701 may be independently used.

Each component of the communication apparatus 700 is described below in detail with reference to FIG. 7.

The processor 701 is a control center of the communication apparatus 700, and may be one processor, or may be a collective term of a plurality of processing elements. For example, the processor 701 is one or more central processing units (central processing units, CPUs), or may be an application-specific integrated circuit (application-specific integrated circuit, ASIC), or is configured as one or more integrated circuits implementing embodiments of this application, for example, one or more microprocessors (digital signal processors, DSPs) or one or more field programmable gate arrays (field programmable gate arrays, FPGAs).

The processor 701 may run or execute a software program stored in the memory 702, and invoke data stored in the memory 702, to perform various functions of the communication apparatus 700.

During specific implementation, in an embodiment, the processor 701 may include one or more CPUs, such as a CPU 0 and a CPU 1 shown in FIG. 7.

During specific implementation, in an embodiment, the communication apparatus 700 may alternatively include a plurality of processors, such as the processor 701 and a processor 704 shown in FIG. 7. Each of the processors may be a single-core processor (single-CPU) or may be a multi-core processor (multi-CPU). The processor herein may be one or more communication devices, circuits, and/or processing cores configured to process data (for example, computer program instructions).

The memory 702 may be a read-only memory (read-only memory, ROM) or another type of static storage communication device that can store static information and instructions, or a random access memory (random access memory, RAM) or another type of dynamic storage communication device that can store information and instructions; or may be an electrically erasable programmable read-only memory (electrically erasable programmable read-only memory, EEPROM), a compact disc read-only memory (compact disc read-only memory, CD-ROM) or another optical disc storage, an optical disc storage (including a compact optical disc, a laser disc, an optical disc, a digital versatile disc, a Blu-ray disc, or the like), a magnetic disk storage medium or another magnetic storage communication device, or any other medium that can be configured to carry or store expected program code in a form of instructions or a data structure and that can be accessed by a computer, but is not limited thereto. The memory 702 may be integrated with the processor 701, or may exist independently, and is coupled to the processor 701 through an input/output port (not shown in FIG. 7) of the communication apparatus 700. This is not specifically limited in this embodiment of this application.

The memory 702 is configured to store a software program for executing the solutions of this application, and the processor 701 controls the execution. For the foregoing specific implementation, refer to the following method embodiment. Details are not described herein again.

The transceiver 703 is configured for communication with another communication apparatus. For example, when the communication apparatus 700 is the data orchestration network element, the transceiver 703 may be configured to communicate with the data agent network element, the service request network element, the trust anchor, and/or the like. For another example, when the communication apparatus 700 is the data agent network element, the transceiver 703 may be configured to communicate with the data orchestration network element, the service request network element, the trust anchor, and/or the like. For another example, when the communication apparatus 700 is the service request network element, the transceiver 703 may be configured to communicate with the data orchestration network element, the data agent network element, the trust anchor, and/or the like. In addition, the transceiver 703 may include a receiver and a transmitter (not separately shown in FIG. 7). The receiver is configured to implement a receiving function, and the transmitter is configured to implement a sending function. The transceiver 703 may be integrated with the processor 701, or may exist independently, and is coupled to the processor 701 through an input/output port (not shown in FIG. 7) of the communication apparatus 700. This is not specifically limited in this embodiment of this application.

It needs to be noted that, the structure of the communication apparatus 700 shown in FIG. 7 does not constitute a limitation on the communication apparatus. An actual communication apparatus may include more or fewer components than those shown in the figure, combine some components, or have different component arrangement.

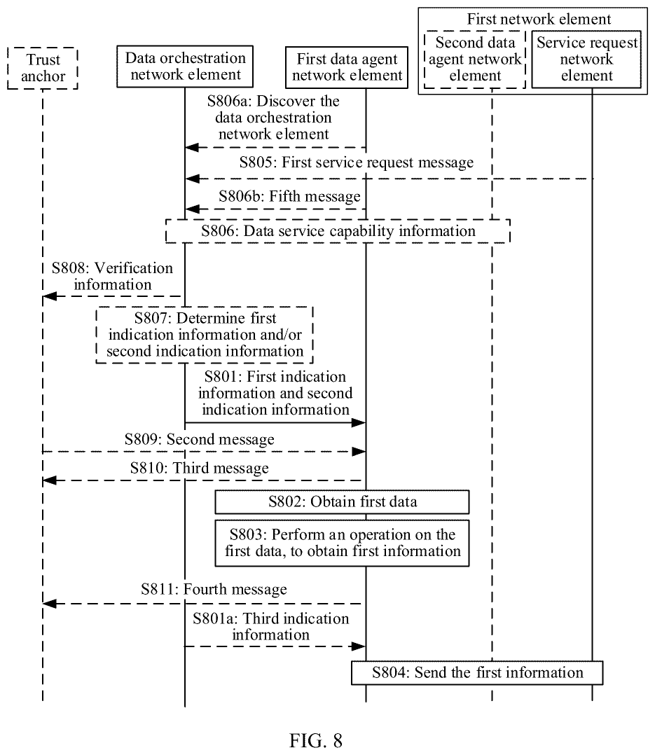

The following specifically describes, with reference to FIG. 8, a communication method according to an embodiment of this application.

For example, FIG. 8 is a schematic flowchart of a communication method according to an embodiment of this application. As shown in FIG. 8, the communication method includes the following steps.
S801: A data orchestration network element sends first indication information and second indication information to a first data agent network element. Correspondingly, the first data agent network element receives the first indication information and the second indication information.

Optionally, the first indication information includes an indication of an operation performed by the first data agent network element on first data. In other words, the first data agent network element may implement, based on the first indication information, the operation specified by the data orchestration network element.

Optionally, in this embodiment of this application, the first data includes but is not limited to one or more of the following data: network data, user data, internet of things data, AI model data, and synthesized data.

Optionally, the network data may include but is not limited to one or more of the following: a log (for example, a debug log, a security log, or a call history record (call history record, CHR) log), an alarm, traffic statistics, configuration data, minimization of drive tests (minimization of drive tests, MDT) data, user session information, integrated sensing and communication (integrated sensing and communication, ISAC) data, digital twin network data, network metadata, a network status, and a network behavior.

For example, the network data may include data acquired by an access network device, data acquired by a terminal device, and/or the like.

Optionally, the user data may include but is not limited to one or more of the following: user subscription information, for example, a user profile (profile), and the like.

Optionally, the internet of things data may include but is not limited to one or more of the following: environment data, sensor-type data, and measurement data of an internet of things terminal.

For example, the internet of things data may include data acquired by an SIoT terminal device and data acquired by a non-SIoT terminal device by using an internet of things gateway.

Optionally, the AI model data may include but is not limited to one or more of the following: a training dataset corresponding to a task, a test dataset corresponding to the task, local/global model data, and AI metadata.

Optionally, the AI model data may be generated by training original data or pre-processed original data.

Optionally, the synthesized data may be artificially synthesized data.

For example, a face may be generated through adversarial learning, and data of the face may be considered as synthesized data.

For example, when an amount of a specific type of data is small, for example, an amount of some abnormal data is small, synthesized data may be used.

Optionally, the synthesized data may be used to train an AI model or the like.

Optionally, the data may be classified from a plurality of dimensions such as a data type, a data source, and a data consumer.

It needs to be noted that, the classification of the data is not limited in this embodiment of this application, and the data may be classified into more or fewer types, or the data may be classified into types from another perspective, or the data may not be classified into types.

In this way, diversified data sources and various data types exist in a network, so that processing procedures for the data are greatly different. The data is properly classified, so that the processing procedures can be simplified, system complexity can be reduced, and data services of various data types can be supported.

Optionally, in this embodiment of this application, the first data includes data acquired by the first data agent network element from at least one data source, and/or data received by the first data agent network element from a second network element.

Optionally, in this embodiment of this application, the at least one data source includes one or more of the following: a terminal device, a radio access network device, a core network device, a transfer network device, an OAM device, or the like. In other words, the first data agent network element may directly acquire the data from the data source such as the terminal device, the radio access network device, the core network device, the transfer network device, or the OAM device.

Optionally, in this embodiment of this application, the second network element may be a terminal device, a radio access network device, a core network device, a transfer network device, an OAM device, or the like. In other words, the first data agent network element may receive the data from the terminal device, the radio access network device, the core network device, the transfer network device, the OAM device, or the like.

It needs to be noted that the at least one data source from which the first data agent network element acquires the data is different from the terminal device, the radio access network device, the core network device, the transfer network device, or the OAM device corresponding to the second network element.

Optionally, the second network element may include another data agent network element other than the first data agent network element. For example, the second network element may include a third data agent network element. That is, the third data agent network element sends first data to the first data agent network element.

Optionally, the data received by the first data agent network element from the second network element may include: data acquired by the second network element and/or synthesized data.

For example, the data acquired by the second network element may include but is not limited to one or more of the following data: network data, user data, internet of things data, or AI model data.

Optionally, the data received from the second network element may be synthesized data for the second network element and/or intermediate data.

For example, the synthesized data may be artificially synthesized data.

For example, the intermediate data may be data obtained by performing one or more of the following operations by the second network element. The one or more of the following operations may include: data acquisition, data pre-processing, data storage, data analytics, or data protection.

Optionally, the first data may be data that has been acquired and/or received before the first data agent network element receives the first indication information.

Optionally, the first data may be data that is acquired and/or received after the first data agent network element receives the first indication information.

It needs to be noted that, different from common encoding/decoding, modulation/demodulation, or rate matching, the operation that is performed on the first data and that is indicated in the first indication information includes but is not limited to one or more of the following: target data acquisition, target data pre-processing (including but not limited to data cleaning, redundancy removal, filtering, merging, and the like), target data storage, target data analytics, or target data protection (including but not limited to data anonymization, encryption, and the like).

Optionally, the target data acquisition is acquiring data from the at least one data source. The type for the data acquisition may include but is not limited to one or more of the following: network data, user data, internet of things data, and AI model data.

Optionally, the target data pre-processing includes field extraction of target data, format conversion, redundant data clearing, compression, merging, and the like.

Optionally, the target data storage may include encrypted storage, distributed storage, or the like of the data.

Optionally, the target data analytics may include but is not limited to one or more of the following: data task analytics, AI training, and AI inference.

Optionally, the target data protection may include but is not limited to one or more of the following: k-anonymity (k-anonymity), l-diversity (l-diversity), differential privacy, homomorphic encryption, and secure multi-party computation.

It needs to be noted that, for an implementation of the target data acquisition, the target data pre-processing, the target data storage, the target data analytics, or the target data protection, further refer to descriptions of the function of the data agent network element in FIG. 3. That the data agent network element has a corresponding function may indicate that the data agent network element has a corresponding capability.

Optionally, the second indication information indicates information about a first network element interacting with the first data agent network element. In other words, the first network element may directly interact with the first data agent network element, to transfer data information.

Optionally, the first network element may be another data agent network element, core network device, transfer network device, OAM device, terminal device, or access network device in the communication network.

Optionally, the first network element may be a network element specified by the data orchestration network element.

Optionally, the first network element may be a network element reported by the first data agent network element.

Optionally, the first data agent network element may interact with the first network element based on the information that is about the first network element and that is indicated in the second indication information. In other words, the first data agent network element may determine address information of the first network element, and/or determine that the first network element is the network element specified by the data orchestration network element or the network element specified by the first data agent network element.

Optionally, the information about the first network element includes the address information of the first network element or an identifier of the first network element, or is used to determine the address information that is of the first network element and that is reported by the first data agent network element.

For example, the address information of the first network element may be API interface information of the first network element. The API interface information may include but is not limited to a uniform resource locator (uniform resource locator, URL). Correspondingly, the first data agent network element may interact with the first network element based on the URL.

Alternatively, for example, the address information of the first network element may be an IP address of the first network element.

For example, the identifier of the first network element may be a name of the first network element.

Alternatively, for example, the identifier of the first network element may include an index of the first network element in an operation chain. For example, when the first network element and the first data agent network element form an operation chain, the identifier of the first network element may be the index of the first network element in the operation chain.

In other words, the first data agent network element may determine, based on the information that is about the first network element and that is indicated in the second indication information, that the first network element is the network element specified by the data orchestration network element.

Optionally, the information about the first network element used to determine the address information that is of the first network element and that is reported by the first data agent network element may include the API interface information of the first network element or the IP address of the first network element that is reported by the first data agent network element. In other words, the first data agent network element may determine, based on the information that is about the first network element and that is indicated in the second indication information, that the first network element is the network element reported by the first data agent network element.

Optionally, the information about the first network element may alternatively be used to determine the identifier that is of the first network element and that is reported by the first data agent network element.

For example, the information about the first network element used to determine the identifier that is of the first network element and that is reported by the first data agent network element may include the name or the index that is of the first network element and that is reported by the first data agent network element.

Optionally, the information that is about the first network element interacting with the first data agent network element and that is indicated in the second indication information may include information about a plurality of first network elements. That is, the data orchestration network element may specify that the plurality of first network elements interact with the first data agent network element, so that the first data agent network element multicasts information to the plurality of first network elements.

Optionally, the first indication information and the second indication information may be carried in a same message.

Alternatively, optionally, a message that carries the first indication information is different from a message that carries the second indication information.

For example, the data orchestration network element may first send the first indication information, and then send the second indication information. Alternatively, the data orchestration network element may first send the second indication information, and then send the first indication information.
S802: The first data agent network element obtains the first data.

It needs to be noted that an execution sequence for S802 is not limited in this embodiment of this application. S802 may be performed before or after S801.

For example, a scenario in which S802 is performed after S801 may be, for example, that the operation indicated in the first indication information includes the target data acquisition. In other words, the first data agent network element obtains the first data based on the operation indicated in the first indication information.

For example, a scenario in which S802 is performed before S801 may be, for example, that the operation indicated in the first indication information is that the first data agent network element performs target data pre-processing, target data analytics, target data protection, or the like on the first data stored in the first data agent network element.

In some embodiments, the first data includes the data acquired by the first data agent network element from the at least one data source. The data acquired from the at least one data source includes data of a target data source in the at least one data source. In this scenario, in a possible implementation, S802 may include the following steps.
S802a: The first data agent network element sends a first message to the target data source. Correspondingly, the target data source receives the first message sent by the first data agent network element.

The first message is for requesting the data of the target data source.
S802b: The first data agent network element receives the data from the target data source.

In other words, the first data agent network element may support a data source range of the data acquisition, covering function nodes on a terminal device side, an access network device side, a transfer network device side, a core network device side, and an OAM device side, and support acquisition of a plurality of types of data.

Optionally, the first message may be data subscription (data subscription). Correspondingly, the first data agent network element may receive the data from the target data source by using a data notification (data notify) message.

Optionally, the first message may alternatively be a data request (data request). Correspondingly, the first data agent network element may receive the data from the target data source by using a data response (data response) message.

Optionally, a manner of reporting the data of the target data source includes but is not limited to one or more of the following: immediate reporting, reporting starting at specified time, periodic reporting, or threshold reporting.

Optionally, the first message further includes but is not limited to one or more of the following: a maximum time length of the data reporting, a periodicity of the periodic reporting, a threshold for triggering the data reporting, a data amount for ending the reporting, and time at which the reporting starts and/or time at which the reporting ends.

Optionally, the first message further includes a filter condition for the data acquisition.

Optionally, the filter condition may include but is not limited to one or more of the following: a cell identifier, location information, a capability type of the terminal device, an international mobile equipment identity (international mobile equipment identity, IMEI) type, and a service service type.

In this embodiment of this application, because the first data agent network element may directly acquire the data of the target data source such as the terminal device, the radio access network device, the core network device, the transfer network device, or the OAM device by using an interface design of the first message, the first data agent network element may acquire the plurality of types of data.

In a possible implementation, in the communication method provided in this embodiment of this application, S802 may further include the following step:
S802c: The first data agent network element receives the data from the second network element and one or more of the following information: data description information, key information, or file transfer information.

Optionally, the data description information may be used to describe the first data.

Optionally, the data description information may include a data transmission format of the first data. The data transmission format of the first data may be extensible markup language (eXtensible Markup Language, XML), JSON (javaScript object notation), or ASN.1 (abstract syntax notation dot one).

Optionally, the key information may include a key agreed upon by the first data agent network element and a second data agent network element.

Optionally, the key information may alternatively include a key agreed upon by the first data agent network element and a third data agent network element.

Optionally, the file transfer information may be an identifier of the data agent network element.

Optionally, the identifier of the data agent network element includes a user name or an index in an operation chain.

It needs to be noted that the first data agent network element and the third data agent network element may be different types of data agent network elements or a same type of data agent network element.

For example, assuming that the first data agent network element is deployed in an access network device 1, the third data agent network element may be deployed in an access network device 2 or a terminal device. In this way, inter-domain data agent network elements may be connected, and a cross-domain data service architecture may be formed.
S803: The first data agent network element performs the operation in the first indication information on the first data, to obtain first information.

For example, the first data agent network element obtains the operation in the first indication information; orchestrates the functions of the first data agent network element to form an operation chain, where an output of a former function is an input of a latter function; and processes the first data based on the operation chain, to obtain the first information. The first data agent network element may form the operation chain to decompose the data service, to form coherent data flows, and a plurality of data agent network elements operate in parallel at the same time. Therefore, a response speed of the data service can be improved, and utilization of a network resource can be improved.

Optionally, the first information may be original data, intermediate data, an analytics result, or the like.

It needs to be noted that, for a specific implementation in which the first data agent network element performs the operation in the first indication information on the first data, refer to corresponding descriptions in S801. Details are not described herein again.
S804: The first data agent network element sends the first information based on the information about the first network element. Correspondingly, the first network element receives the first information from the first data agent network element.

Optionally, the first network element may be the second data agent network element. That is, the second indication information may indicate the first data agent network element to transmit the first information to the second data agent network element. In this way, the first data agent network element may send the first information to the second data agent network element, and the second data agent network element may process or forward the first data based on the first indication information corresponding to the second data agent network element.

Optionally, the first network element may be a service request network element. That is, the second indication information may indicate the first data agent network element to transmit the first information to the service request network element.

It needs to be noted that, in FIG. 8, an example in which the first network element is the second data agent network element and/or the service request network element is used for description. Certainly, the first network element may alternatively be another network element. This is not specifically limited in this embodiment of this application.

In addition, when the first network element includes the second data agent network element and the service request network element, the second data agent network element and the service request network element may be separately deployed.

In other words, in this embodiment of this application, the first data agent network element may obtain the first information based on the first indication information, interact with the first network element based on the information indicated in the second indication information, to form a data service architecture in which the first data agent network element directly interacts with the first network element, and further process the data in a mobile communication network based on the data service architecture formed by the first data agent network element and the first network element, to implement a data service.

As shown in FIG. 8, in some embodiments, the communication method provided in this embodiment of this application may further include the following step:
S805: The service request network element sends a first service request message to the data orchestration network element. Correspondingly, the data orchestration network element receives the first service request message.

Optionally, the first service request message may be for requesting an application service or a service service.

Optionally, the service request network element may be an application, an application server, a network service network element, or the like.

In this embodiment of this application, the application service may be a service requested by the application or the application server, and the service service may be a service requested by the network service network element. In different scenarios, services requested by using the first service request message may be different.

For example, the first service request message may be for requesting but is not limited to be for requesting one or more of the following services: a service related to network data, a service related to user data, a service related to AI model data, and a service related to internet of things data.

Optionally, the network data may include but is not limited to one or more of the following: a log (for example, a debug log, a security log, or a call history record), an alarm, traffic statistics, configuration data, MDT data, user session information, ISAC data, digital twin network data, network metadata, a network status, and a network behavior.

For example, the network data may include data acquired by an access network device, data acquired by a terminal device, and/or the like.

For example, the network service network element sends a first service request message to the data orchestration network element, where the first service request message is for requesting to access user subscription data of a target terminal device. After receiving the first service request message, the data orchestration network element may deliver the first indication information and the second indication information to the first data agent network element. The first data agent network element acquires the user subscription data of the target terminal device from the target terminal device based on the first indication information. Then, the first data agent network element interacts with the network service network element based on the second indication information, and sends the user subscription data of the target terminal device to the network service network element.

For example, an application that is of an operator and that is used for network planning and optimization (which may be briefly referred to as a network planning and optimization application) sends a first service request message to the data orchestration network element, where the first service request message is for requesting to train a federated learning model, and the federated learning model is used to predict quality of service.

For example, the network planning and optimization application sends the first service request message to the data orchestration network element, where the first service request message is for requesting to predict quality of service of an area A.
S806: At least one data agent network element sends data service capability information of each of the at least one data agent network element to the data orchestration network element. Correspondingly, the data orchestration network element receives the data service capability information from the at least one data agent network element.

For example, as shown in FIG. 8, the first data agent network element sends, to the data orchestration network element, data service capability information corresponding to the first data agent network element. The second data agent network element sends, to the data orchestration network element, data service capability information corresponding to the second data agent network element.

In some embodiments, data service capability information of any one of the one or more data agent network elements may include but is not limited to one or more of the following: an identifier of the any one data agent network element, location information of the any one data agent network element, a data acquisition capability, a data pre-processing capability, a data storage capability, a data reporting capability, a data analytics capability, a capability of interacting with the service request network element, a data protection capability, and a data compression capability.

Optionally, there may be a correspondence between the data service capability information and the identifier of the data agent network element.

Optionally, the location information may be information about a geographical location, and the location information may include longitude and latitude, or the like.

Optionally, the data acquisition capability may include a type of data that can be acquired. The type of the data may include but is not limited to one or more of the following: network data, user data, internet of things data, or AI model data.

Optionally, the data pre-processing capability may include a supported pre-processing manner, for example, field extraction of the original data, format conversion, redundant data clearing, compression, or merging.

Optionally, the data storage capability may include but is not limited to one or more of the following: a data storage capacity, an encryption algorithm for storing data, or a storage manner.

Optionally, the data reporting capability may include but is not limited to one or more of the following: a minimum reporting periodicity, an amount of data reported at a time, a maximum amount of reported data, whether file upload is supported, or whether streaming data is supported.

Optionally, the data analytics capability may include but is not limited to one or more of the following: a supported analytics task, whether AI training is supported, or whether AI inference is supported.

Optionally, the capability of interacting with the service request network element may include but is not limited to: whether an application programming interface service can be provided.

Optionally, the data protection capability may include but is not limited to one or more of the following: supported data protection technologies, for example, k-anonymity, l-diversity, differential privacy, homomorphic encryption, or secure multi-party computation.

Optionally, the data compression capability may include but is not limited to one or more of the following: a supported data compression algorithm, for example, Huffman coding or arithmetic coding, and the like.

It needs to be noted that, for implementations of the data acquisition capability, the data pre-processing capability, the data storage capability, the data reporting capability, the data analytics capability, the capability of interacting with the service request network element, the data protection capability, and the data compression capability, further refer to descriptions of the function of the data agent network element in FIG. 3. That the data agent network element has a corresponding function may indicate that the data agent network element has a corresponding capability.
S807: The data orchestration network element determines, based on the first service request message and one or more pieces of data service capability information, the at least one data agent network element and the first indication information and/or the second indication information that correspond/corresponds to each of the at least one data agent network element.

For example, the data orchestration network element may determine the service requirement on the first data based on the service requested by using the first service request message.

For example, the one or more pieces of data service capability information are in one-to-one correspondence with one or more data agent network elements.

For example, an example in which a plurality of pieces of data service capability information include data service capability information 1, data service capability information 2, and data service capability information 3 is used. The data service capability information 1 corresponds to a data agent network element 1, the data service capability information 2 corresponds to a data agent network element 2, and the data service capability information 3 corresponds to a data agent network element 3.

It needs to be noted that, in this embodiment of this application, the plurality of data agent network elements may be different types of data agent network elements or a same type of data agent network element.

For example, the data agent network element 1 to the data agent network element 3 are all (or deployed on) access network devices. For another example, the data agent network element 1 is deployed on a core network device, the data agent network element 2 is deployed on an access network device, and the data agent network element 3 is deployed on a terminal device. For another example, the data agent network element 1 is deployed on an access network device, the data agent network element 2 is deployed on a terminal device, and the data agent network element 3 is deployed on a terminal device.

For example, the at least one data agent network element may be at least one of the one or more data agent network elements.

For example, the data orchestration network element determines, from the data agent network element 1, the data agent network element 2, and the data agent network element 3 based on the service requirement, the data service capability information 1, the data service capability information 2, and the data service capability information 3, a data agent network element participating in a current data service, for example, selects the data agent network element 1 and the data agent network element 2 to participate in the current data service, and determines first indication information and second indication information respectively corresponding to the data agent network element 1 and the data agent network element 2.

For example, first indication information of any one of the at least one data agent network element may indicate an operation performed by the any one data agent network element on the first data.

For example, second indication information of any one of the at least one data agent network element may indicate a first network element corresponding to the any one data agent network element.

For example, the first indication information corresponding to the data agent network element 1 indicates an operation performed by the data agent network element 1 on the first data or data generated based on the first data. The second indication information corresponding to the data agent network element 1 indicates a sending address of first information obtained by performing the operation on the first data by the data agent network element 1.

For example, the service requirement corresponds to at least one of the one or more pieces of data service capability information.

For example, the data agent network element determines, based on the service requested by the first service request message and the at least one piece of data service capability information, a data agent network element participating in a current data service. A data service capability of the selected data agent network element needs to be capable of meeting the service requirement that is on the first data and that is in the service requested by using the first service request message, and the selected data agent network element needs to have a capability of completing the current data service. In this way, the data service can be implemented.

For example, assuming that the data agent network element directly communicating with the service request network element is the first data agent network element, the second indication information may include but is not limited to one or more of the following: an address of the first data agent network element, an identifier of the first data agent network element, or an index of the first data agent network element.

Optionally, the first indication information and/or the second indication information may be determined based on data service capability information of the at least one data agent network element.

For example, a data agent network element that has a capability of interacting with the service request network element is selected from the at least one data agent network element, as a data agent network element that directly communicates with the service request network element.

In other words, the data orchestration network element may select, from the determined data agent network elements participating in the current data service, a data agent network element that directly communicates with the service request network element. The following uses a scenario of requesting the data analytics as an example to describe how the data orchestration network element determines a data agent network element participating in a current data service and first indication information and second indication information that correspond to the data agent network element.

For example, assuming that the first service request message is for requesting user data analytics, the data orchestration network element may obtain a service requirement based on the first service request message. The service requirement may include: the area A, the data acquisition, the data pre-processing, the data analytics, and the interaction with the service request network element.

The data orchestration network element determines, from the data agent network element 1, the data agent network element 2, and the data agent network element 3 based on the service requirement, the data service capability information 1, the data service capability information 2, and the data service capability information 3, data agent network elements participating in the current data service. The data service capability information 1 to the data service capability information 3 respectively correspond to the data agent network element 1 to the data agent network element 3.

It is assumed that the data service capability information 1 includes: the area A, the supported data pre-processing, the supported data storage, the supported interaction with the service request network element, and the supported data acquisition.

It is assumed that the data service capability information 2 includes: the area A, the supported data pre-processing, the supported data analytics, and the supported data acquisition.

It is assumed that the data service capability information 3 includes: an area B, the supported data pre-processing, the supported data storage, and the supported data acquisition.

The data orchestration network element may determine, based on the requirement information, the data service capability information 1, the data service capability information 2, and the data service capability information 3, that the data agent network element 1 and the data agent network element 2 can jointly implement the service requirement in the requirement information. First, a geographical location of the data agent network element 3 is the area B instead of the area A, and second, the data agent network element 3 does not support the data analytics. Therefore, the data agent network element 3 cannot participate in the current data service.

The data orchestration network element determines, based on the requirement information, the data service capability information 1, and the data service capability information 2, first indication information 1 and second indication information 1 that correspond to the data agent network element 1, and first indication information 2 and second indication information 2 that correspond to the data agent network element 2. For example, the first indication information 1 includes: original data acquisition and the data pre-processing. The second indication information 1 includes: the interaction with the service request network element. The first indication information 2 includes: original data acquisition, the data pre-processing, and the data analytics. The second indication information 2 includes: interaction with the data agent network element 1.

In this embodiment of this application, the at least one data agent network element sends the data service capability information of each of the at least one data agent network element to the data orchestration network element. Therefore, the data orchestration network element may learn of the data service capability information of each of the at least one data agent network element, so that the data orchestration network element may orchestrate, for the at least one data agent network element, an operation chain that can efficiently implement the data service.

It needs to be noted that, in this embodiment of this application, steps S801 to S804 may be performed after step S807. That is, based on the method shown in FIG. 8, the data orchestration network element receives the first service request message, and determines, from the one or more data agent network elements based on the first service request message and the one or more pieces of data service capability information, that the first data agent network element participates in the current data service. The first data agent network element obtains the first indication information and/or the second indication information that correspond/corresponds to the current data service. The first data agent network element obtains the first data, and performs the operation in the first indication information on the first data. In this way, the data service can be implemented.

As shown in FIG. 8, in a possible implementation, before S806, the communication method provided in this embodiment of this application may include the following step:
S806a: The first data agent network element discovers the data orchestration network element through an interface. Correspondingly, the first data agent network element may interact with the data orchestration network element through the interface.

Optionally, the interface may be an interface of a service-based architecture (Service-based Architecture, SBA).

As shown in FIG. 8, in a possible implementation, the communication method provided in this embodiment of this application may further include the following step:
S806b: The first data agent network element sends a fifth message to the data orchestration network element. Correspondingly, the data orchestration network element receives the fifth message from the first data agent network element. The fifth message is used to determine that the first data agent network element is in a communication state. That is, the data orchestration network element may determine, based on the fifth message, that the first data agent network element can perform the operation on the first data, so that the data orchestration network element sends the first indication information and/or the second indication information to the first data agent network element.

Optionally, the fifth message may include but is not limited to the identifier and/or address information of the first data agent network element.

It needs to be noted that an execution sequence for S806b is not specifically limited in this embodiment of this application. For example, S806b may be performed before or after S806.

As shown in FIG. 8, in a possible implementation, after S801, the communication method provided in this embodiment of this application may include the following step:
S801a: The data orchestration network element sends third indication information to the first data agent network element. Correspondingly, the first data agent network element receives the third indication information from the data orchestration network element.

Optionally, the third indication information includes information indicating the first data agent network element to stop performing the operation in the first indication information on the first data.

For example, a scenario in which the data orchestration network element sends the third indication information to the first data agent network element may be, for example, that the first indication information does not indicate time of the operation performed on the first data. Further, the data orchestration network element may send the third indication information to the first data agent network element, to indicate the first data agent network element to stop performing the operation in the first indication information on the first data.

It needs to be noted that S801a may be performed before or after S803. An execution sequence of S801a and S803 is not limited in this embodiment of this application.

In a possible implementation, S807 may specifically include: When the service request network element has permission to access the first data, the data orchestration network element determines, based on the first service request message and the one or more pieces of data service capability information, the at least one data agent network element and the first indication information and the second indication information that correspond to each of the at least one data agent network element. In this way, a trusted data service can be implemented.

As shown in FIG. 8, in a possible implementation, the communication method provided in this embodiment of this application may further include the following step:
S808: The data orchestration network element sends verification information to a trust anchor based on the first service request message. Correspondingly, the trust anchor receives the verification information sent by the data orchestration network element.

Optionally, the verification information includes an identifier of the service request network element that sends the first service request message and an identifier of the first data.

Optionally, the trust anchor sends response information to the data orchestration network element based on the verification information. The response information indicating whether the service request network element that sends the first service request message has the permission to access the first data is sent to the data orchestration network element.

In this way, the data orchestration network element determines the data agent network element participating in this data service and the corresponding first indication information and second indication information only when the service request network element has the permission to access the first data; or when the service request network element has no permission to access the first data, the data orchestration network element does not perform this step of determining the data agent network element participating in the data service and the corresponding first indication information and second indication information, so that an E2E trusted service requirement on data can be implemented.

As shown in FIG. 8, in a possible implementation, the communication method provided in this embodiment of this application may further include the following step:
S809: The trust anchor sends a second message to the first data agent network element. Correspondingly, the first data agent network element receives the second message from the trust anchor.

Optionally, the second message indicates that the first data agent network element has permission to access the data acquired from the at least one data source. In other words, the first data agent network element may determine whether the first data agent network element has the permission to access the data that is in the first data and that is acquired from the at least one data source, and report permission information to the data orchestration network element, so that the data orchestration network element may determine the first indication information and/or the second indication information based on the permission for accessing the data for the first data agent network element.

In some embodiments, the second network element in the foregoing embodiment may be the third data agent network element.

Optionally, the second message may further indicate that the first data agent network element has the permission to access the first data of the third data agent network element. In this way, when determining that the first data agent network element has the permission to access the first data of the third data agent network element, the first data agent network element may receive the first data sent by the third data agent network element.

It needs to be noted that S809 may be performed before or after S801. An execution sequence of S801 and S809 is not limited in this embodiment of this application.

As shown in FIG. 8, in a possible implementation, before S809, the communication method provided in this embodiment of this application may further include the following step:
S810: The first data agent network element sends a third message to the trust anchor. Correspondingly, the trust anchor receives the third message from the first data agent network element.

Optionally, the third message is used to verify whether the first data agent network element has permission to access the data that is in the first data and that is acquired from the at least one data source. In other words, the first data agent network element may determine, by sending the third message, whether the first data agent network element has the permission to access the data that is in the first data and that is acquired from the at least one data source. In this way, when the permission for the data that is in the first data and that is acquired from the at least one data source changes, or a new data source with unknown access permission appears in the at least one data source, the first data agent network element may obtain the updated access permission by using the third message, and determine whether to perform this step of obtaining the first data. This can avoid unauthorized access or save signaling resources.

Optionally, if the first data agent network element does not have the permission to access the data that is in the first data and that is acquired from the at least one data source, the first data agent network element may not perform step S802a. That is, the trusted data service can be implemented.

It needs to be noted that S810 may be performed before or after S801. An execution sequence of S801 and S810 is not limited in this embodiment of this application.

As shown in FIG. 8, in a possible implementation, the communication method provided in this embodiment of this application may further include the following step:
S811: The first data agent network element sends a fourth message to the trust anchor. Correspondingly, the trust anchor receives the fourth message from the first data agent network element.

Optionally, the fourth message includes an identifier of first target data in the first data and an identifier of a visitor of the first target data.

Optionally, the first target data in the first data may be user data or data including user personal information or privacy.

Optionally, the fourth message is for recording an event of accessing the first target data by the visitor of the first target data. In other words, when the first data agent network element has behavior of accessing sensitive data in the first data, the first data agent network element may send the fourth message to the trust anchor to record the behavior. In this way, when the first data includes the user data, E2E compliance detection on the user data can be implemented.

In a possible implementation, the method provided in this embodiment of this application may further include: The data orchestration network element sends information about a data security and privacy protection technology repository and/or information about an analytics tool repository to the first data agent network element. Correspondingly, the first data agent network element receives updated information about a data security and privacy protection technology repository and/or updated information about an analytics tool repository from the data orchestration network element.

Optionally, the data security and privacy protection technology repository is used by the first data agent network element to perform data protection on second target data in the first data.

Optionally, the second target data may be data on which the data protection is indicated to be performed in the first indication information.

Optionally, the information about the data security and privacy protection technology repository may include but is not limited to one or more of the following: an identifier of the data security and privacy protection technology repository, an index of the data security and privacy protection technology repository, and the data security and privacy protection technology repository.

Optionally, the analytics tool repository is used by the first data agent network element to perform data analytics on third target data in the first data.

Optionally, the third target data may be data on which the data analytics is indicated to be performed in the first indication information.

Optionally, the information about the analytics tool repository may include but is not limited to one or more of the following: an identifier of the analytics tool repository, an index of the analytics tool repository, and the analytics tool repository itself.

For example, the at least one data agent network element may include the first data agent network element. The first data agent network element receives the updated information about the data security and privacy protection technology repository and/or the updated information about the analytics tool repository from the data orchestration network element.

In other words, if the data security and privacy protection technology repository, the analytics tool repository, and the like are updated, the data orchestration network element may push either updated information or the data security and privacy protection technology repository, the analytics tool repository, and the like to the data agent network element. In this way, data security protection, data privacy protection, and the like can be implemented.

It needs to be noted that, that the data orchestration network element sends the first indication information and/or the second indication information to the first data agent network element and that the data orchestration network element sends information about a data security and privacy protection technology repository and/or information about an analytics tool repository may be performed in a same step, or may be separately performed. This is not limited in this application.

In embodiments of this application, unless otherwise specified, reference may be made to each other for same or similar parts in embodiments. In embodiments of this application and the implementations/methods/implementation methods in embodiments, unless otherwise specified or a logical collision occurs, terms and/or descriptions are consistent and may be mutually referenced between different embodiments and between the implementations/methods/implementation methods in embodiments. Technical features in the different embodiments and the implementations/methods/implementation methods in embodiments may be combined to form a new embodiment, implementation, method, or implementation method based on an internal logical relationship of the technical features. The foregoing descriptions are implementations of this application, but are not intended to limit the protection scope of this application.

In this embodiment of this application, actions of the first data agent network element in steps S801 to S811 may be performed by the processor 701 in the communication apparatus 700 shown in FIG. 7 by invoking application program code stored in the memory 702 to indicate the first data agent network element to perform the actions. This is not limited in this embodiment.

It may be understood that, in the foregoing embodiments, the method and/or the steps implemented by the first data agent network element may alternatively be implemented by a component (for example, a processor, a chip, a chip system, a circuit, a logical module, or software) that may be used in the first data agent network element.

The foregoing mainly describes the solutions provided in this application. Correspondingly, this application further provides a communication apparatus. The communication apparatus is configured to implement the various methods in the foregoing method embodiments. The communication apparatus may be the first data agent network element in the foregoing method embodiment, or an apparatus including the first data agent network element, or a component, for example, a chip or a chip system, that may be used in the first data agent network element.

It may be understood that, to implement the foregoing functions, the communication apparatus includes corresponding hardware structures and/or software modules for performing the functions. Persons skilled in the art should easily be aware that, in combination with units and algorithm steps of the examples described in embodiments disclosed in this specification, this application may be implemented by hardware or a combination of hardware and computer software. Whether a function is performed by hardware or hardware driven by computer software depends on particular applications and design constraint conditions of the technical solutions. Persons skilled in the art may use different methods to implement the described functions for each particular application, but it should not be considered that the implementation goes beyond the scope of this application.

In embodiments of this application, the communication apparatus is divided into functional modules based on the foregoing method embodiment. For example, each functional module corresponding to each function may be obtained through division, or two or more functions may be integrated into one processing module. The integrated module may be implemented in a form of hardware, or may be implemented in a form of a software functional module. It needs to be noted that in embodiments of this application, the division into the modules is an example, and is merely logical function division. During actual implementation, another division manner may be used.

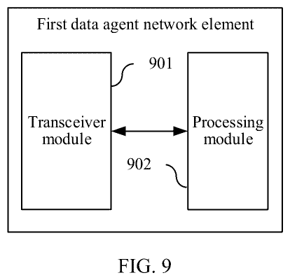

An example in which the communication apparatus is the first data agent network element in the foregoing method embodiment is used. FIG. 9 is a diagram of a structure of a first data agent network element 900. The first data agent network element 900 includes: a transceiver module 901 and a processing module 902.

In some embodiments, the first data agent network element 900 may further include: a storage module (not shown in FIG. 9), configured to store program instructions and data.

In some embodiments, the processing module 902 is configured to obtain first data. The transceiver module 901 is configured to receive first indication information and second indication information. The first indication information includes an indication of an operation performed by the first data agent network element on the first data, the second indication information indicates information about a first network element interacting with the first data agent network element, and the information about the first network element includes address information of the first network element or an identifier of the first network element, or is used to determine the address information that is of the first network element and that is reported by the first data agent network element. The processing module 902 is further configured to perform the foregoing operation on the first data, to obtain first information. The transceiver module 901 is further configured to send the first information based on the information about the first network element.

In some embodiments, the first data includes data acquired by the first data agent network element from at least one data source, and/or data received by the first data agent network element from a second network element.

In some embodiments, the operation indicated in the first indication information includes but is not limited to one or more of the following: target data acquisition, target data pre-processing, target data storage, target data analytics, or target data protection.

In some embodiments, the first data includes the data acquired by the first data agent network element from the at least one data source, and the at least one data source includes one or more of the following: a terminal device, a radio access network device, a core network device, a transfer network device, or an operations, administration and maintenance OAM device.

In some embodiments, the first data includes the data acquired by the first data agent network element from the at least one data source, the data acquired from the at least one data source includes data of a target data source in the at least one data source, and that the processing module 902 obtains first data specifically includes: sending a first message to the target data source by using the transceiver module 901, where the first message is for requesting the data of the target data source; and receiving the data from the target data source by using the transceiver module 901.

In some embodiments, the first data includes the data acquired by the first data agent network element from the at least one data source, and the transceiver module 901 is further configured to receive a second message from a trust anchor, where the second message indicates that the first data agent network element has permission to access the data acquired from the at least one data source.

In some embodiments, the transceiver module 901 is further configured to send a third message to the trust anchor before receiving the second message from the trust anchor, where the third message is used to verify whether the first data agent network element has the permission to access the data acquired from the at least one data source.

In some embodiments, the first data includes the data acquired by the first data agent network element from the at least one data source, and the data acquired from the at least one data source includes but is not limited to one or more of the following data: network data, user data, internet of things data, or AI model data.

In some embodiments, the first data includes the data received by the first data agent network element from the second network element, and that the processing module 902 obtains first data specifically includes: receiving, by using the transceiver module 901, the data from the second network element and one or more of the following information: data description information, key information, or file transfer information.

In some embodiments, the transceiver module 901 is further configured to send a fourth message to the trust anchor, where the fourth message includes an identifier of first target data in the first data and an identifier of a visitor of the first target data, and the fourth message is for recording an event of accessing the first target data by the visitor of the first target data.

In some embodiments, the transceiver module 901 is further configured to receive information about a data security and privacy protection technology repository and/or information about an analytics tool repository, where the data security and privacy protection technology repository is used by the first data agent network element to perform data protection on second target data in the first data, and the analytics tool repository is used by the first data agent network element to perform data analytics on third target data in the first data.

In some embodiments, the first data agent network element in this embodiment of this application may be deployed in one or more of the following devices: the terminal device, the radio access network device, the core network device, the transfer network device, or the operations, administration and maintenance OAM device.

In some embodiments, the transceiver module 901 is further configured to send data service capability information, where the data service capability information is used to determine the first indication information and/or the second indication information.

In some embodiments, the data service capability information includes one or more of the following: an identifier of the first data agent network element, location information of the first data agent network element, a data pre-processing capability of the first data agent network element, a data storage capability of the first data agent network element, a data reporting capability of the first data agent network element, a data analytics capability of the first data agent network element, an interaction capability of the first data agent network element, a data protection capability of the first data agent network element, or a data compression capability of the first data agent network element.

All related content of the steps in the foregoing method embodiment may be cited in function descriptions of the corresponding functional modules. Details are not described herein again.

In this application, the first data agent network element 900 is presented in a form of functional modules obtained through division in an integrated manner. The “module” herein may be an application-specific integrated circuit (application-specific integrated circuit, ASIC), a circuit, a processor and a memory that execute one or more software or firmware programs, an integrated logic circuit, and/or another device that can provide the foregoing functions.

In some embodiments, in terms of hardware implementation, persons skilled in the art may figure out that the first data agent network element 900 may be in a form of the communication apparatus 700 shown in FIG. 7.

In an example, functions/implementation processes of the processing module 902 in FIG. 9 may be implemented by the processor 701 in the communication apparatus 700 shown in FIG. 7 by invoking the computer-executable instructions stored in the memory 702. Functions/implementation processes of the transceiver module 901 in FIG. 9 may be implemented by the transceiver 703 in the communication apparatus 700 shown in FIG. 7.

In some embodiments, when the first data agent network element 900 in FIG. 9 is a chip or a chip system, functions/implementation processes of the transceiver module 901 may be implemented through an input/output interface (or a communication interface) of the chip or the chip system, and functions/implementation processes of the processing module 902 may be implemented via a processor (or a processing circuit) of the chip or the chip system.

Because the first data agent network element 900 provided in this embodiment may perform the foregoing communication method, for technical effects that can be achieved by the first data agent network element, refer to the foregoing method embodiment. Details are not described herein again.

In some embodiments, the first data agent network element in this application may be further implemented by using the following: one or more field programmable gate arrays (field programmable gate arrays, FPGAs), a programmable logic device (programmable logic device, PLD), a controller, a state machine, gate logic, a discrete hardware component, any other suitable circuit, or any combination of circuits that can perform various functions described in this entire application.

In some embodiments, this application further provides a communication apparatus. The communication apparatus includes: a processor, configured to implement the method in the foregoing any method embodiment.

In a possible implementation, the communication apparatus further includes a memory. The memory is configured to store a computer program and data that are necessary. The computer program may include instructions. The processor may invoke the instructions in the computer program stored in the memory to indicate the communication apparatus to perform the method in the foregoing any method embodiment. Certainly, the communication apparatus may not include the memory.

In another possible implementation, the communication apparatus further includes an interface circuit. The interface circuit is a code/data read/write interface circuit, and the interface circuit is configured to: receive computer-executable instructions (where the computer-executable instructions are stored in a memory, and may be directly read from the memory, or may be read via another device) and send the computer-executable instructions to the processor.

In still another possible implementation, the communication apparatus further includes a communication interface, and the communication interface is configured to communicate with a module outside the communication apparatus.

It may be understood that the communication apparatus may be a chip or a chip system. When the communication apparatus is the chip system, the communication apparatus may include a chip, or may include the chip and another discrete device. This is not specifically limited in this embodiment of this application.

This application further provides a computer-readable storage medium. The computer-readable storage medium stores a computer program or instructions. When the computer program or the instructions are executed by a computer, functions in the foregoing any method embodiment are implemented.

This application further provides a computer program product. When the computer program product is executed by a computer, functions in the foregoing any method embodiment are implemented.

Persons of ordinary skill in the art may understand that, for the purpose of convenient and brief description, for a detailed working process of the foregoing system, apparatus, and unit, refer to a corresponding process in the foregoing method embodiment. Details are not described herein again.

It may be understood that, the system, the apparatus, and the method described in this application may alternatively be implemented in other manners. For example, the described apparatus embodiments are merely examples. For example, the division into the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separated, this is, may be located in one position, or may be distributed on a plurality of network units. Components displayed as units may be or may be not physical units. Some or all of the units may be selected based on an actual requirement to achieve the objective of the solutions of embodiments.

In addition, functional units in embodiments of this application may be integrated into one processing unit, or each of the units may exist alone physically, or two or more units are integrated into one unit.

All or some of the foregoing embodiments may be implemented by software, hardware, firmware, or any combination thereof. When a software program is used to implement the embodiments, the embodiments may be implemented completely or partially in a form of a computer program product. The computer program product includes one or more computer instructions. When the computer program instructions are loaded and executed on the computer, the procedures or functions according to embodiments of this application are all or partially generated. The computer may be a general-purpose computer, a dedicated computer, a computer network, or other programmable apparatuses. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium may be any usable medium that can be accessed by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (solid-state drive, SSD)), or the like. In embodiments of this application, the computer may include the foregoing apparatuses.

Although this application is described with reference to embodiments, in a process of implementing this application that claims protection, persons skilled in the art may understand and implement another variation of the disclosed embodiments by viewing the accompanying drawings, disclosed content, and appended claims. In the claims, “comprising” (comprising) does not exclude another component or another step, and “a” or “one” does not exclude a case of “a plurality of”. A single processor or another unit may implement several functions enumerated in the claims. Some measures are recorded in dependent claims that are different from each other, but this does not mean that these measures cannot be combined to produce a better effect.

Although this application is described with reference to specific features and embodiments thereof, it is clear that various modifications and combinations may be made to them without departing from the spirit and scope of this application. Correspondingly, the specification and the accompanying drawings are merely example descriptions in this application defined by the appended claims, and are considered as any of or all modifications, variations, combinations or equivalents that cover the scope of this application. It is clear that persons skilled in the art can make various modifications and variations to this application without departing from the spirit and scope of this application. In this way, this application is intended to cover these modifications and variations of this application provided that they fall within the scope of protection defined by the claims of this application and their equivalent technologies.

What is claimed is:

1. A communication method, comprising:
obtaining, by a first data agent network element, first data;
receiving, by the first data agent network element, first indication information and second indication information, wherein the first indication information comprises an indication of an operation performed by the first data agent network element on the first data, the second indication information indicates information about a first network element interacting with the first data agent network element, and the information about the first network element comprises address information of the first network element or an identifier of the first network element, or is used to determine the address information that is of the first network element and that is reported by the first data agent network element;
performing, by the first data agent network element, the operation on the first data, to obtain first information; and
sending, by the first data agent network element, the first information based on the information about the first network element.

2. The method according to claim 1, wherein the operation indicated in the first indication information comprises one or more of the following: target data acquisition, target data pre-processing, target data storage, target data analytics, or target data protection.

3. The method according to claim 1, wherein the first data comprises the data acquired by the first data agent network element from the at least one data source, and the method further comprises:
receiving, by the first data agent network element, a second message from a trust anchor, wherein the second message indicates that the first data agent network element has permission to access the data acquired from the at least one data source.

4. The method according to claim 1, wherein the first data comprises the data acquired by the first data agent network element from the at least one data source, and the data acquired from the at least one data source comprises one or more of the following data: network data, user data, internet of things data, or artificial intelligence model data; or
wherein the first data comprises the data received by the first data agent network element from the second network element, and the obtaining, by a first data agent network element, first data comprises: receiving, by the first data agent network element, the data from the second network element and one or more of the following information: data description information, key information, or file transfer information.

5. The method according to claim 1, wherein the method further comprises:
sending, by the first data agent network element, a fourth message to the trust anchor, wherein the fourth message comprises an identifier of first target data in the first data and an identifier of a visitor of the first target data, and the fourth message is for recording an event of accessing the first target data by the visitor of the first target data.

6. The method according to claim 1, wherein the method further comprises:
receiving, by the first data agent network element, information about a data security and privacy protection technology repository and/or information about an analytics tool repository, wherein the data security and privacy protection technology repository is used by the first data agent network element to perform data protection on second target data in the first data, and the analytics tool repository is used by the first data agent network element to perform data analytics on third target data in the first data.

7. A communication method, comprising:
generating, by a data orchestration network element, first indication information and second indication information; and
sending, by the data orchestration network element, the first indication information and the second indication information to a first data agent network element, wherein the first indication information comprises an indication of an operation performed by the first data agent network element on first data, the second indication information indicates information about a first network element interacting with the first data agent network element, and the information about the first network element comprises address information of the first network element or an identifier of the first network element, or is used to determine the address information that is of the first network element and that is reported by the first data agent network element.

8. The method according to claim 7, wherein the first data comprises data acquired by the first data agent network element from at least one data source, and/or data received by the first data agent network element from a second network element.

9. The method according to claim 7, wherein the method further comprises:
sending information about a data security and privacy protection technology repository and/or information about an analytics tool repository to the first data agent network element, wherein the data security and privacy protection technology repository is used by the first data agent network element to perform data protection on second target data in the first data, and the analytics tool repository is used by the first data agent network element to perform data analytics on third target data in the first data.

10. The method according to claim 7, wherein the method further comprises:
receiving, by the data orchestration network element, data service capability information from the first data agent network element, wherein the data service capability information is used to determine the first indication information and/or the second indication information.

11. A communication apparatus, comprising a processor coupled to a memory storing instructions, which when executed by the processor, cause the apparatus to:
obtain first data;
receive first indication information and second indication information, wherein the first indication information comprises an indication of an operation performed by the communication apparatus on the first data, the second indication information indicates information about a first network element interacting with the communication apparatus, and the information about the first network element comprises address information of the first network element or an identifier of the first network element, or is used to determine the address information that is of the first network element and that is reported by the communication apparatus;
perform the operation on the first data, to obtain first information; and
send the first information based on the information about the first network element.

12. The apparatus according to claim 11, wherein the operation indicated in the first indication information comprises one or more of the following: target data acquisition, target data pre-processing, target data storage, target data analytics, or target data protection.

13. The apparatus according to claim 11, wherein the first data comprises the data acquired by the communication apparatus from the at least one data source, and wherein when the instructions are executed by the processor, further cause the apparatus to:
receive a second message from a trust anchor, wherein the second message indicates that the communication apparatus has permission to access the data acquired from the at least one data source.

14. The apparatus according to claim 11, wherein the first data comprises the data acquired by the communication apparatus from the at least one data source, and the data acquired from the at least one data source comprises one or more of the following data: network data, user data, internet of things data, or artificial intelligence model data; or
wherein the first data comprises the data received by the communication apparatus from the second network element, and wherein when the instructions are executed by the processor, further cause the apparatus to: receive the data from the second network element and one or more of the following information: data description information, key information, or file transfer information.

15. The apparatus according to claim 11, wherein when the instructions are executed by the processor, further cause the apparatus to:
send a fourth message to the trust anchor, wherein the fourth message comprises an identifier of first target data in the first data and an identifier of a visitor of the first target data, and the fourth message is for recording an event of accessing the first target data by the visitor of the first target data.

16. The apparatus according to claim 11, wherein when the instructions are executed by the processor, further cause the apparatus to:
receive information about a data security and privacy protection technology repository and/or information about an analytics tool repository, wherein the data security and privacy protection technology repository is used by the communication apparatus to perform data protection on second target data in the first data, and the analytics tool repository is used by the communication apparatus to perform data analytics on third target data in the first data.

17. A communication apparatus, comprising a processor coupled to a memory storing instructions, which when executed by the processor, cause the apparatus to:
generate, first indication information and second indication information; and
send, the first indication information and the second indication information to a first data agent network element, wherein the first indication information comprises an indication of an operation performed by the first data agent network element on first data, the second indication information indicates information about a first network element interacting with the first data agent network element, and the information about the first network element comprises address information of the first network element or an identifier of the first network element, or is used to determine the address information that is of the first network element and that is reported by the first data agent network element.

18. The apparatus according to claim 17, wherein the first data comprises data acquired by the first data agent network element from at least one data source, and/or data received by the first data agent network element from a second network element.

19. The apparatus according to claim 17, wherein when the instructions are executed by the processor, further cause the apparatus to:
send information about a data security and privacy protection technology repository and/or information about an analytics tool repository to the first data agent network element, wherein the data security and privacy protection technology repository is used by the first data agent network element to perform data protection on second target data in the first data, and the analytics tool repository is used by the first data agent network element to perform data analytics on third target data in the first data.

20. The apparatus according to claim 17, wherein when the instructions are executed by the processor, further cause the apparatus to:
receive data service capability information from the first data agent network element, wherein the data service capability information is used to determine the first indication information and/or the second indication information.
